(19) United States
(12) Patent Application Publication
(10) Pub. No.: US 2011/0084601 A1
(43) Pub. Date: Apr. 14, 2011

(54) WHITE LIGHT EMISSION ORGANIC ELECTROLUMINESCENT ELEMENT, ILLUMINATING DEVICE AND DISPLAY

(75) Inventors: Yoriko Nakayama, Tokyo (JP); Toshihiko Iwasaki, Tokyo (JP); Kunimasa Hiyama, Tokyo (JP)

(73) Assignee: KONICA MINOLTA HOLDINGS, INC., Tokyo (JP)

(21) Appl. No.: 12/934,943

(22) PCT Filed: Jun. 26, 2009
(86) PCT No.: PCT/JP2009/061730

§ 371 Date: Sep. 27, 2010

(30) Foreign Application Priority Data
Jul. 1, 2008 (JP) 2008-172218

(51) Int. Cl. H01J 1/62

(52) U.S. Cl. 313/504

(57) ABSTRACT

Disclosed is a coating type organic EL element having excellent chromaticity stability to driving current, excellent chromaticity stability during continuous driving and excellent color rendering property.

### FIELD OF THE INVENTION

This invention relates to a white light emission organic electroluminescent element, and to an illuminating device and a display each employing an white light emission organic electroluminescent element.

### TECHNICAL BACKGROUND

As an emission type electronic displaying device, there is an electroluminescent display (hereinafter referred to as ELD). As devices constituting the ELD, there are mentioned an inorganic electroluminescent element (hereinafter referred to as inorganic EL element) and an organic electroluminescent element (hereinafter referred to as organic EL element).

The inorganic EL element has been used for a plane-shaped light source, but a high voltage alternating current has been required to drive the element.

An organic EL element has a structure in which a light emission layer containing a light emission compound is provided between a cathode and an anode, and an electron and a hole are injected into the light emission layer and recombined to form an exciton. The element emits light, utilizing light (fluorescent light or phosphorescent light) generated by inactivation of the exciton, and the element can emit light by applying a relatively low voltage of from several volts to several decade volts. The element has a wide viewing angle and a high visuality since the element is of self light emission type. Further, the element is a thin, complete solid device, and therefore, the element is marked from the viewpoint of space saving and portability.

Further, the major feature of the organic EL element is also in the form of a surface light source differing from conventionally employed main light sources such as a light emitting diode or a cold-cathode tube. Possible applications, which can effectively utilize the above characteristic, include a light source for an illuminating device and backlights of various displays. In particular, it is also appropriate to employ them as a backlight of liquid crystal full color displays, of which demand is markedly increasing in recent years.

When the organic EL element is employed as the light source for an illuminating device or the display backlights as described above, it is employed as a light source which has white or so-called warm white (hereinafter collectively referred to as white).

As a method of obtaining a white light emission, there is a method in which three light emission layers of B/G/R are laminated or two light emission layers of B/Y are laminated (refer to for example, Patent Document 1), a method in which emission pixels emitting multi colors, for example, three colors of blue, green and red are separately coated, and the three color lights are simultaneously emitted and mixed to obtain white, a method which obtains white employing color conversion dyes (for example, a combination of a blue light emission material and a color conversion fluorescent dye), or a method which obtains white by color mixture in a single element containing a plurality of light emission materials differing in the emission wavelength.

However, when the light emission layers having a different emission color are laminated, it has problem in that the emission position shifts due to variation of driving current or variation after continuous driving, resulting in variation of emission color. A method in which emission pixels of multi colors are separately coated has problem in that the manufacturing process is complex including positioning of a mask, resulting in poor yield, and a method employing color conversion dyes has problem in that emission efficiency is low.

Further, there is a method which restrains shift of the emission position by incorporating a mixture of all the light emission materials in a single light emission layer, however, such a mixture of the light emission materials causes transfer of energy due to difference in emission energy level among the light emission materials.

Further, a method is disclosed which improves emission efficiency employing energy transfer among light emission materials contained in the same layer (refer to for example, Patent Document 2). In this method, however, even when light emission materials different in emission color are mixed, light is only emitted from a specific light emission material, but white emission cannot be obtained.

That is, a single light emission layer cannot provide preferred white emission in the same content ratio of light emission materials as in multi-layers. In order to obtain a preferred white emission from the single light emission layer, it is necessary to form a single light emission layer having an extremely low content ratio of a light emission material with a low emission energy level to a light emission material with a high emission energy level. In the manufacture of an organic EL element according to a vapor deposition method, it is difficult to adjust the content ratio of the light emission materials.

As a manufacturing method of an organic EL element, there is a wet process (a spin coating method, a casting method, an ink jet method, a spraying method, a printing method and the like). In recent years, attention has been focused on a manufacturing method according to the wet process for the reason that it does not require a vacuum process or is easy in continuous production. In the wet process, a light emission layer having an intended composition can be formed by adjusting the content ratio of materials used upon preparing a coating solution for the light emission layer. It is advantageous when light emission layers having a composition greatly different in the content of materials are formed.

There is disclosure (refer to for example, Patent Document 3) that a light emission element provides high efficiency in which two or more kinds of light emission materials are contained in the same light emission layer and one of the light emission materials is an ortho-metalated complex. However, this light emission element has high efficiency as compared to a light emission element comprising no ortho-metalated complex, but its efficiency is still insufficient since it employs a fluorescence emission material as a part of the light emission materials.

### PRIOR ART DOCUMENTS

### Patent Documents

Patent Document 1: Japanese Patent O.P.I. Publication No. 7/41759

Patent Document 2: Japanese Patent O.P.I. Publication No. 2006/41395

Patent Document 3: Japanese Patent O.P.I. Publication No. 2001/319780

### DISCLOSURE OF THE INVENTION

### Problems to be Solved by the Invention

An object of the invention is to provide a coating type organic EL element having excellent chromaticity stability to driving current, excellent chromaticity stability during continuous driving and excellent color rendering properties.

### Means for Solving the Above Problems

The present invention has been attained by the following constitutions.

1. A white light emission organic electroluminescent element comprising an anode side electrode, a cathode side electrode and at least one organic layer provided between the anode side electrode and the cathode side electrode, the element comprising light emission layers, in which at least one of the light emission layers contains a plurality of light emission materials having a different emission color, wherein emission spectrum of the element has at least three emission maximums in a wavelength region of from 420 nm to 650 nm, and an emission minimum in a wavelength region of from 480 nm to 510 nm, in which a wavelength difference between two adjacent emission maximum wavelengths is from 30 nm to 70 nm.

2. The white light emission organic electroluminescent element of item 1 above, wherein the emission spectrum has the emission maximum at least in each of a wavelength region of from 420 nm to 480 nm, a wavelength region of from 510 nm to 610 nm and a wavelength region of from 555 nm to 650 nm.

3. The white light emission organic electroluminescent element of item 1 or 2 above, wherein the emission spectrum has four emission maximums in a wavelength region of from 420 nm to 650 nm.

4. The white light emission organic electroluminescent element of any one of items 1 through 3 above, wherein in the emission spectrum of two light emission materials having an emission maximum adjacent to each other among the plurality of light emission materials, the emission intensity is 30 or more at the wavelength where the emission spectrum of each of the two light emission materials are overlaps, when the intensity of each emission maximum is set at 100.

5. The white light emission organic electroluminescent element of any one of items 1 through 4 above, wherein light emitted from the light emission layer has a color temperature of from 2500K to 7000K and Δuv falling within the range of ±0.02.

6. The white light emission organic electroluminescent element of any one of items 1 through 5 above, wherein the emission spectrum of at least one of the plurality of light emission materials has an emission maximum in a wavelength region of from 420 nm to 480 nm, and has two emission maximums which are double peaks.

7. The white light emission organic electroluminescent element of any one of items 1 through 6 above, wherein all of the plurality of light emission materials are phosphorescence emission materials.

8. The white light emission organic electroluminescent element of any one of items 1 through 7 above, wherein the light emission materials include a compound having at least one of partial structures represented by the following formulae (A) to (C),

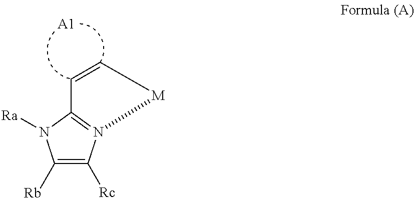

wherein Ra represents a hydrogen atom, an aliphatic group, an aromatic hydrocarbon group or an aromatic heterocyclic group; Rb and Rc independently represent a hydrogen atom or a substituent; A1 represents an atomic group necessary to form an aromatic hydrocarbon ring or an aromatic heterocyclic ring; and M represents Ir or Pt.

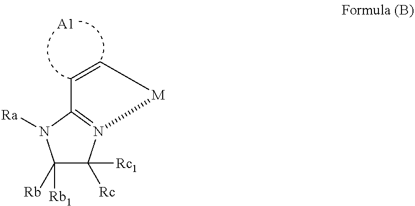

wherein Ra represents a hydrogen atom, an aliphatic group, an aromatic hydrocarbon group or an aromatic heterocyclic group; Rb, Rc, Rb and Rc independently represent a hydrogen atom or a substituent; A1 represents an atomic group necessary to form an aromatic hydrocarbon ring or an aromatic heterocyclic ring; and M represents Ir or Pt,

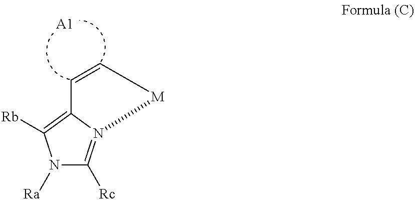

wherein Ra represents a hydrogen atom, an aliphatic group, an aromatic hydrocarbon group or an aromatic heterocyclic group; Rb and Rc independently represent a hydrogen atom or a substituent; A1 represents an atomic group necessary to form an aromatic hydrocarbon ring or an aromatic heterocyclic ring; and M represents Ir or Pt.

9. The white light emission organic electroluminescent element of any one of items 1 through 8 above, wherein the element comprises two or more kinds of light emission materials having an emission maximum in a wavelength region of from 555 nm to 650 nm.

10. The white light emission organic electroluminescent element of any one of items 1 through 9 above, wherein the following formula is satisfied,

λmax(½)−λmax≧40 nm

wherein λmax represents the longest emission maximum wavelength in the emission maximums, and λmax (½) represents a wavelength which is on the wavelength side longer than the longest emission maximum wavelength and which exhibits ½ of the intensity of the emission maximum at the longest emission maximum wavelength.

11. The white light emission organic electroluminescent element of any one of items 1 through 10 above, wherein the total content of the light emission materials in the light emission layer is from 5 to 30% by mass.

12. The white light emission organic electroluminescent element of any one of items 1 through 11 above, wherein when the content of a light emission material having an emission maximum in a wavelength region of from 420 nm to 480 nm in the light emission layer is represented by α and the content of a light emission material having an emission maximum in a wavelength region of from 555 nm to 650 nm in the light emission layer is represented by β, a ratio by mass β/α satisfies the following inequality,

β/α<0.1

13. The white light emission organic electroluminescent element of any one of items 1 through 12 above, wherein when the content of a light emission material having an emission maximum in a wavelength region of from 420 nm to 480 nm in the light emission layer is represented by α and the content of a light emission material having an emission maximum in a wavelength region of from 555 nm to 650 nm in the light emission layer is represented by β, a ratio by mass β/α satisfies the following inequality,

β/α<0.05

14. The white light emission organic electroluminescent element of any one of items 1 through 13 above, wherein at least one of the light emission layers is formed employing a wet process.

15. An illuminating device comprising the white light emission organic electroluminescent element of any one of items 1 through 14 above.

16. A display comprising the white light emission organic electroluminescent element of any one of items 1 through 14 above.

### EFFECTS OF THE INVENTION

The invention can provide a white light emission organic EL element having excellent chromaticity stability to driving current, excellent chromaticity stability during continuous driving and excellent color rendering properties, and provide an illuminating device and a display each comprising the white light emission organic EL element.

### BRIEF EXPLANATION OF THE DRAWINGS

FIG. 1 shows a schematic drawing of one example of a display comprising an organic EL element.

FIG. 2 is a schematic drawing of a display section A.

FIG. 3 is a schematic drawing of a pixel.

FIG. 4 is a schematic drawing of a full color display employing a passive matrix.

FIG. 5 is a schematic drawing of an illuminating device.

FIG. 6 is a sectional view of an illuminating device.

### PREFERRED EMBODIMENT OF THE INVENTION

In the white light emission organic EL element of the invention, the constitution of any one of items 1 through 14 described above can provide a white light emission organic EL element having excellent chromaticity stability to driving current, excellent chromaticity stability during continuous driving and excellent color rendering properties. In addition, the invention can provide an illuminating device and a display each comprising the white light emission organic EL element.

Next, each constituent in the invention will be explained in detail.

### <<Light Emission Layer>>

The light emission layer in the white light emission organic EL element of the invention will be explained below. Herein, the spectral properties (emission spectrum, light emission maximum, etc.), a preparing method of a light emission layer and the like will be mainly explained. (A manufacturing method of the element will be explained also.)

The present inventors have studied the above problems, and as a result, they have found that a white light emission organic electroluminescent element can provide the effects of the invention, i.e., excellent chromaticity stability to driving current, excellent chromaticity stability during continuous driving and excellent color rendering property, which comprises an anode side electrode, a cathode side electrode and at least one organic layer provided between the anode side electrode and the cathode side electrode, the element comprising one or more light emission layers as a constituent layer, in which at least one of the light emission layers contains a plurality of light emission materials having a different emission color, wherein the emission spectrum of the element has at least three emission maximums in a wavelength region of from 420 nm to 650 nm and an emission minimum in a wavelength region of from 480 nm to 510 nm, the light emission layer being formed by a wet process

The emission spectrum as the element can be obtained as an admixture of the emission spectrum of each of the plurality of the light emission materials contained in the light emission layer. The white light emission organic EL element with high white light emission efficiency and excellent color rendering property can be obtained by employing a combination of light emission materials or a layer constitution to give emission spectrum having an emission minimum in a wavelength region of from 480 nm to 510 nm.

### (Emission Maximums of Light Emission Layer, Emission Spectrum, Preferred Embodiment of Light Emission Materials)

In the invention, the emission spectrum of the light emission layer, emission maximums of the light emission layer and preferred embodiments of light emission materials contained in the light emission layer will be explained below.

With respect to details of the light emission layer in the invention (a host compound, an emission dopant (hereinafter also referred to as simply a light emission material) contained therein) or other constituent layers in the organic EL element in the invention, detailed explanation will be made in the layer constitution of an organic EL element described later.

(a) It is preferred that the emission maximum is at least in each of a wavelength region of from 420 nm to 480 nm, a wavelength region of from 510 nm to 610 nm and a wavelength region of from 555 nm to 650 nm.

(b) It is preferred that the emission spectrum has four emission maximums in a wavelength region of from 420 nm to 650 nm.

(c) It is preferred that in the emission maximums, the wavelength difference between two adjacent emission maximums is from 30 nm to 70 nm. When one light emission material has plural emission maximums, it is sufficient that the wavelength difference between one of the plural emission maximums and the emission maximum of other light emission materials is from 30 nm to 70 nm.

(d) It is preferred that in the emission spectrum of two light emission materials having an emission maximum adjacent to each other among the plurality of light emission materials, the emission intensity is 30 or more at the wavelength where the emission spectrum of each of the two light emission materials overlaps, when the intensity of each emission maximum is set at 100. When the emission minimum located between the two emission maximums is too low, a color of that wavelength region cannot be realized, resulting in deterioration of color rendering property.

(e) It is preferred that light emitted from the light emission layer has a color temperature of from 2500K to 7000K, and has Δuv falling within the range of ±0.02.

(f) It is preferred that the emission spectrum of at least one of the plurality of light emission materials has an emission maximum in a wavelength region of from 420 nm to 480 nm, and has two emission maximums which are double peaks.

(g) It is preferred that all of the plurality of light emission materials are phosphorescence emission materials.

With respect to the phosphorescence emission material (hereinafter also referred to as phosphorescence emission dopant or phosphorescence emitting dopant), detailed explanation will be made in the layer constitution of an organic EL element described later.

It is preferred in the invention that all of the light emission materials contained in the light emission layer are phosphorescence emission materials.

(h) It is preferred that the light emission layer comprises two or more kinds of light emission materials having emission maximum in a wavelength region of from 555 nm to 650 nm.

(i) It is preferred that the following formula is satisfied in the emission maximums,

λmax(½)−λmax≧40 nm

wherein λmax represents the longest emission maximum wavelength, and λmax (½) represents a wavelength which is on the wavelength side longer than the longest emission maximum wavelength and which exhibits ½ of the intensity of the emission maximum at the longest emission maximum wavelength.

(j) It is preferred that the total content of the light emission materials in the light emission layer is from 5 to 30% by mass.

(k) It is preferred that when the content of a light emission material having an emission maximum in a wavelength region of from 420 nm to 480 nm in the light emission layer is represented by α and the content of a light emission material having emission maximum in a wavelength region of from 555 nm to 650 nm in the light emission layer is represented by β, the mass ratio β/α satisfies the following inequality,

β/α<0.1

(l) It is preferred that when the content of a light emission material having an emission maximum in a wavelength region of from 420 nm to 480 nm in the light emission layer is represented by α and the content of a light emission material having an emission maximum in a wavelength region of from 555 nm to 650 nm in the light emission layer is represented by β, the mass ratio β/α satisfies the following inequality,

β/α<0.05

The light emission layer in the white light emission organic EL element of the invention preferably contains a light emission host compound (also referred to as simply a host compound or a host) and at least one kind of a light emission material (also referred to as simply a light emission dopant) as a guest material, and more preferably contains a light emission host compound and three or more kinds of light emission materials.

The host compound also will be explained in the layer constitution of the organic EL element described later.

### <<Manufacturing Method of White Light Emission Organic EL Element>>

The manufacturing method of the white light emission organic EL element of the invention will be explained below. The layer constitution (also referred to as the constituent layer) of the white light emission organic EL element of the invention will be explained in detail later.

The manufacturing method of the white light emission organic EL element of the invention is a method of manufacturing an organic electroluminescent element comprising at least one organic layer provided between an anode side electrode and a cathode side electrode and comprising at least one light emission layer as the constituent layer. A method of forming the light emission material can be selected from a dry process such as vapor deposition or a wet process such as coating.

When a plurality of light emission materials are contained in one light emission layer, application energy is concentrated on light emission materials with low energy level and therefore, the addition amount of the light emission materials do not always correlate with the emission amount.

Accordingly, in order to obtain an intended emission, it is necessary that the addition amount of the light emission materials with low energy level is as small as possible so that application energy is injected also to other light emission materials. When a light emission layer, in which the mixing ratio of light emission materials is too large, is formed employing vacuum deposition, it may be difficult to control.

In contrast, a wet process can form a light emission layer having an intended composition by adjusting the mixing ratio of materials to be used on preparing a coating solution, and is advantageous when a light emission layer having a composition greatly different in material content is formed.

As the wet process used in the invention, there are mentioned a spin coating method, a casting method, an ink jet method, a spraying method or a printing method.

A spin coating method, an ink jet method, a spraying method and a printing method are preferred, since a uniform layer is likely to be formed and a pinhole is difficult to be formed.

### (Coating Solvent Including Dispersion Solvent)

As a coating solvent (also referred to as simply a solvent) for preparing the coating solution in the invention, there can be used methylene chloride (40° C.); ketones such as methyl ethyl ketone (79.6° C.), tetrahydrothran (66° C.) or cyclohexanone (155.65° C.); aliphatic acid esters such as ethyl acetate (77.111° C.); halogenated hydrocarbons such as dichlorobenzene (an meta isomer: 173.0° C., an ortho isomer: 180.4° C., a para isomer: 174.1° C.); aromatic hydrocarbons such as toluene, xylene (an ortho isomer: 144.4° C., a meta isomer: 139.1° C., a para isomer: 138.3° C.), mesitylene and cyclohexylbenzene; aliphatic hydrocarbons such as cyclohexane (80.77° C.), decaline (a cis isomer: 195.7° C., a trans isomer: 187.2° C.) and dodecane (210.3° C.); and organic solvents such as DMF (153° C.) and DMSO (208° C.).

In the above, the numerical values in the parentheses represent a boiling point at atmospheric pressure (1013 hPa).

### <<One Embodiment of Manufacturing Method of Organic EL Element of the Invention>>

As one embodiment (one example) of the manufacturing method of the organic EL element of the invention, a manufacturing method of an organic EL element having the constitution, Anode/Hole injecting layer/Hole transporting layer/Light emission layer/Electron transporting layer/Electron injecting layer/Cathode will be explained below.

A thin layer of an intended electrode material such as a material for an anode is formed on a suitable substrate by vapor deposition or sputtering to prepare an anode side electrode (also referred to as simply an anode) having a thickness of not more than 1 μm, and preferably from 10 nm to 200 nm.

Then, organic compound thin layers (organic component layers) such as a hole injecting layer, a hole transporting layer, a light emission layer, a hole blocking layer and an electron injecting layer, which constitute the organic EL element, are formed on the resulting anode.

As a method of forming these layers, there are mentioned a vapor deposition method or a wet process (a spin coating method, a casting method, an ink jet method, a spraying method or a printing method). In the invention, a spin coating method, an ink jet method, a spraying method and a printing method are preferred, since a uniform layer is likely to be formed and a pinhole is difficult to be formed.

When a host material solution and a guest material solution each prepared separately were jetted and mixed on a substrate employing an ink jet method or a spraying method, it is preferred that the solutions are jetted on the substrate so that the droplets are jetted onto the substrate from nozzles while moving the substrate, the nozzles or both of them, and mixed on the substrate.

### (Coating Solvent Including Dispersion Solvent)

In the invention, as a liquid medium for dissolving or dispersing organic EL materials which is used in the preparation of a coating solution (or a dispersion solution, there can be used ketones such as methyl ethyl ketone and cyclohexanone; aliphatic acid esters such as ethyl acetate; halogenated hydrocarbons such as dichlorobenzene; aromatic hydrocarbons such as toluene, xylene, mesitylene and cyclohexylbenzene; aliphatic hydrocarbons such as cyclohexane, decaline and dodecane; and organic solvents such as DMF and DMSO.

Further, the dispersion of materials for an organic EL element can be carried out employing a dispersion method such as an ultrasonic wave dispersion method, a high shearing force dispersion method or a medium dispersion method.

After these layers have been formed, a thin layer comprised of a material for a cathode is formed thereon to prepare a cathode, employing, for example, a deposition method or sputtering method to give a thickness of not more than 1 and preferably from 50 to 200 nm. Thus, a desired organic EL element is obtained.

Further, the organic EL element can be prepared in the reverse order, in which the cathode, the electron transporting layer, the hole blocking layer, the light emission layer, the hole transporting layer, the hole injecting layer, and the anode are formed in that order.

Next, details of the constituent of the organic EL element of the invention will be sequentially explained.

### <<Layer Constitution of Organic EL Element>>

Preferred embodiments of the layer constitution of the organic EL element of the invention will be shown below, but the invention is not limited thereto.

(i): Anode/Light emission layer unit/Electron transporting layer/Cathode
(ii): Anode/Hole transporting layer/Light emission layer/Electron transporting layer/Cathode
(iii): Anode/Hole transporting layer/Light emission layer/Hole blocking layer/Electron transporting layer/Cathode
(iv): Anode/Hole transporting layer/Light emission layer/Hole blocking layer/Electron transporting layer/Cathode buffering layer/Cathode
(v): Anode/Anode buffering layer/Hole transporting layer/Light emission layer/Hole blocking layer/Electron transporting layer/Cathode buffering layer/Cathode

### <<Light Emission Layer>>

Herein, a light emission material (for example, a host compound, a light emission dopant) contained in the light emission layer will be explained mainly.

The light emission layer in the invention is a layer where electrons and holes, which are injected from electrodes, an electron transporting layer or a hole transporting layer, are recombined to emit light. The portions where light emits may be in the light emission layer or at the interface between the light emission layer and the layer adjacent thereto.

The thickness of the light emission layer is not particularly limited. In view of improving layer uniformity and stability of emitted light color to driving electric current without requiring unnecessary high voltage on light emission, the above thickness is adjusted to be in the range of preferably from 2 nm to 200 nm, and more preferably from 5 nm to 100 nm.

It is preferred that the light emission layer of the organic EL element of the invention contains a light emission host compound and at least one kind of light emission material as a guest material. It is more preferred that the light emission layer of the organic EL element of the invention contains a light emission host compound and three or more kinds of light emission materials as a guest material.

Next, a host compound (also referred to as light emission host and the like) and a light emission material (also referred to as a light emission dopant compound) contained in the light emission layer will be explained.

### (Light Emission Material)

The light emission material (also referred to as the light emission dopant compound) in the invention will be explained.

A fluorescence emission material (also referred to as a fluorescent compound) or a phosphorescence emission material (also referred to as a phosphorescence emitter, a phosphorescent compound or a phosphorescence emitting compound) can be used as the light emission material in the invention. As the light emission material (also referred to simply as light emission dopant) used in the light emission layer or the light emission unit of the organic EL element of the invention, a phosphorescence emission material is preferably used in addition to the host compound as described above from a viewpoint of obtaining an organic EL element with higher emission efficiency.

### (Phosphorescence Emission Material)

The phosphorescence emission material (also refereed to as a phosphorescence emission dopant) in the invention will be explained.

The phosphorescence emission material in the invention is a compound which emits light from the excitation triplet, can emit phosphorescence at room temperature (25° C.), and has a phosphorescent quantum yield at 25° C. of not less than 0.01. The phosphorescent quantum yield at 25° C. is preferably not less than 0.1.

The phosphorescent quantum yield can be measured according to a method described in the fourth edition “Jikken Kagaku Koza 7”, Bunko II, page 398 (1992) published by Maruzen. The phosphorescent quantum yield can be measured in a solution employing various kinds of solvents. The phosphorescence dopant in the invention is a compound, in which the phosphorescent quantum yield measured employing any one of the solvents satisfies the above-described definition (not less than 0.01).

The light emission of the phosphorescence emission material is divided in two types in principle, one is an energy transfer type in which recombination of a carrier occurs on the host compound to which the carrier is transported to excite the host compound, the resulting energy is transferred to the phosphorescence emission material, and light is emitted from the phosphorescence emission material, and the other is a carrier trap type in which recombination of a carrier occurs on the phosphorescence emission material, which is a carrier trap material, and light is emitted from the phosphorescence emission material. However, in each type, it is necessary that the energy level of a phosphorescence emission material in an excited state is lower than that of the host compound in an excited state.

The phosphorescence emission material can be suitably selected from known ones used in the light emission layer of an organic EL element.

The phosphorescence emission material in the invention is preferably a complex compound containing a metal belonging to groups 8 to 10 on the periodic table, and is more preferably an iridium compound, an osmium compound, a platinum compound (a platinum complex) or a rare earth complex, and most preferably an iridium compound.

In the invention, the phosphorescence emission material is preferably a compound having at least one of partial structures represented by formula (A) to (C) above.

<<At Least One Partial Structure Selected from Formulae (A) to (C) Above>>

At least one partial structure selected from formulae (A) to (C) will be explained below.

In the formulae (A) to (C), examples of the aliphatic group represented by Ra include an alkyl group (for example, a methyl group, an ethyl group, a propyl group, a butyl group, a pentyl group, an iso-pentyl group, a 2-ethylhexyl group, an octyl group, an undecyl group, a dodecyl group, or a tetradecyl group); and an cycloalkyl group (for example, a cyclopentyl group or a cyclohexyl group).

These groups may further have a substituent represented by Rb or Rc as described later.

In the formulae (A) to (C), examples of the aromatic hydrocarbon group represented by Ra include a phenyl group, a tolyl group, an azulenyl group, an anthryl group, a phenanthryl group, a pyrenyl group, a crycenyl group, a naphthacenyl group, an o-terphenyl group, an m-terphenyl group, a p-terphenyl group, an acenaphthenyl group, a coronenyl group, a fluorenyl group, and a perylenyl group.

These groups may further have a substituent represented by Rb or Rc as described later.

In the formulae (A) to (C), examples of the aromatic heterocyclic group represented by Ra include a pyridyl group, a pyrimidinyl group, a furyl group, a pyrrolyl group, an imidazolyl group, a benzimidazolyl group, a pyrazolyl group, a pyrazinyl group, a triazolyl group (for example, a 1,2,4-triazole-1-yl group or a 1,2,3-triazole-1-yl group), an oxazolyl group, a benzoxazolyl group, a thiazolyl group, an isooxazolyl group, an isothiazolyl group, a furazanyl group, a thienyl group, a quinolyl group, a benzofuryl group, a dibenzofuryl group, a benzothienyl group, a dibenzothienyl group, an indolyl group, a carbazolyl group, a carbolinyl group, a diazacarbazolyl group (in which one of the carbon atoms constituting the carboline ring of the carbolinyl group is substituted with a nitrogen atom), a quinoxalinyl group, a pyridazinyl group, a triazinyl group, a quinazolinyl group and a phthalazinyl group.

These groups may further have a substituent represented by Rb or Rc as described later.

In the formulae (A) to (C), examples of the substituent represented by Rb, Rc, Rb₁ or Rc₁ include an alkyl group (for example, a methyl group, an ethyl group, a propyl group, an iso-propyl group, a tert-butyl group, a pentyl group, a hexyl group, an octyl group, a dodecyl group, a tridecyl group, a tetradecyl group or a pentadecyl group); an cycloalkyl group (for example, a cyclopentyl group or a cyclohexyl group); an alkenyl group (for example, a vinyl group or an allyl group); an alkynyl group (for example, an ethynyl group or a propargyl group); an aryl group (for example, a phenyl group or a naphthyl group); an aromatic heterocyclic group (for example, a furyl group, a thienyl group, a pyridyl group, a pyridazinyl group, a pyrimidinyl group, a pyrazinyl group, a triazinyl group, an imidazolyl group, a pyrazolyl group, a thiazolyl group, a quinoxalinyl group or a phthalazinyl group); a heterocyclic ring group (for example, a pyrrolidyl group, an imidazolidyl group, a morpholyl group or an oxazolidyl group); an alkoxy group (for example, a methoxy group, an ethoxy group, a propyloxy group, a pentyloxy group, a hexyloxy group, an octyloxy group or a dodecyloxy group); a cycloalkoxy group (for example, a cyclopentyloxy group or a cyclohexyloxy group), an aryloxy group (for example, a phenoxy group or a naphthyloxy group); an alkylthio group (for example, a methylthio group, an ethylthio group, a propylthio group, a pentylthio group, a hexylthio group, an octylthio group or a dodecylthio group); a cycloalkylthio group (for example, a cyclopentylthio group or a cyclohexylthio group), an arylthio group (for example, a phenylthio group or a naphthylthio group); an alkoxycarbonyl group (for example, a methyloxycarbonyl group, an ethyloxycarbonyl group, a butyloxycarbonyl group, an octyloxycarbonyl group or a dodecyloxycarbonyl group); an aryloxycarbonyl group (for example, a phenyloxycarbonyl group or a naphthyloxycarbonyl group); a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group or a 2-pyridylaminosulfonyl group); an acyl group (for example, an acetyl group, an ethylcarbonyl group, a propylcarbonyl group, a pentylcarbonyl group, a cyclohexylcarbonyl group, an octylcarbonyl group, a 2-ethylhexylcarbonyl group, a dodecylcarbonyl group, a phenylcarbonyl group, a naphthylcarbonyl group, or a pyridylcarbonyl group); an acyloxy group (for example, an acetyloxy group, an ethylcarbonyloxy group, a butylcarbonyloxy group, an octylcarbonyloxy group, a dodecylcarbonyloxy group, or a phenylcarbonyloxy group), an amido group (for example, a methylcarbonylamino group, an ethylcarbonylamino group, a dimethylcarbonylamino group, a propylcarbonylamino group, a pentylcarbonylamino group, a cyclohexylcarbonylamino group, a 2-ethylhexylcarbonylamino group, an octylcarbonylamino group, a dodecylcarbonylamino group, a phenylcarbonylamino group or a naphthylcarbonylamino group); a carbamoyl group (for example, an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecylaminocarbonyl group, a phenylaminocarbonyl group, a naphthylaminocarbonyl group or a 2-pyridylaminocarbonyl group); a ureido group (for example, a methylureido group, an ethylureido group, a pentylureido group, a cyclohexylureido group, an octylureido group, a dodecylureido group, a phenylureido group, a naphthylureido group, or a 2-pyridylaminoureido group); a sulfinyl group (for example, a methylsulfinyl group, an ethylsulfinyl group, a butylsulfonyl group, a cyclohexylsulfinyl group, a 2-ethylhexylsulfinyl group, a dodecylsulfinyl group, a phenylsulfonyl group, a naphthylsulfinyl group or a 2-pyridylsulfinyl group); an alkylsulfonyl group (for example, a methylsulfonyl group, an ethylsulfonyl group, a butylsulfonyl group, a cyclohexylsulfonyl group, a 2-ethylhexylsulfonyl group or a dodecyl sulfonyl group); an arylsulfonyl group (for example, a phenylsulfonyl group, a naphthylsulfonyl group or a 2-pyridylsulfonyl group); an amino group (for example, an amino group, an ethylamino group, a dimethylamino group, a butylamino group, a cyclopentylamino group, a 2-ethylhexylamino group, a dodecylamino group, an anilino group, a naphthylamino group, or a 2-pyridylamino group); a halogen atom (for example, a fluorine atom, a chlorine atom or a bromine atom); a fluorinated hydrocarbon group (for example, a fluoromethyl group, a trifluoromethyl group, a pentafluoroethyl group or a pentafluorophenyl group); a cyano group; an nitro group; a hydroxyl group, a mercapto group; and a silyl group (for example, a trimethylsilyl group, a triisopropylsilyl group, a triphenylsilyl group or a phenyldiethylsilyl group).

These substituents may further have the substituent represented by Rb or Rc as described above.

In the formulae (A) to (C), examples of the aromatic hydrocarbon ring represented by A1 include a benzene ring, a biphenyl ring, a naphthalene ring, an azulene ring, an anthracene ring, a phenanthrene ring, a pyrene ring, a chrysene ring, a naphthacene ring, a triphenylene ring, an o-terphenyl ring, an m-terphenyl ring, a p-terphenyl ring, an acenaphthene ring, a coronene ring, a fluorene ring, a fluoroanthrene ring, a naphthacene ring, a pentacene ring, a perylene ring, a pentaphene ring, a picene ring, a pyrene ring, a pyranthrene ring, and an anthraanthorene ring.

These substituents may further have the substituent represented by Rb or Rc as described above.

In the formulae (A) to (C), examples of the aromatic heterocyclic ring represented by A1 include a furan ring, a thiophene ring, a pyridine ring, a pyridazine ring, a pyrimidine ring, a pyrazine ring, a triazine ring, a benzimidazole ring, an oxadiazole ring, a triazole ring, an imidazole ring, a pyrazole ring, a thiazole ring, an indole ring, a benzimidazole ring, a benzothiazole ring, a benzoxazole ring, a quinoxaline ring, a quinazoline ring, a phthalazine ring, a carbazole ring, a carboline ring, and a diazacarbazole ring (in which one of the carbon atoms of the hydrocarbon ring constituting a carboline ring is further replaced with a nitrogen atom).

These rings may further have the substituent represented by Rb or Rc as described above.

The structure represented by any one of formulae (A) through (C) forms a partial structure of the light emission material. In order for the partial structure itself to form a completed structure of the light emission material, the number of ligands corresponding to the valence of M in the partial structure is necessary.

Examples of the ligand include a halogen atom (for example, a fluorine atom, a chlorine atom, a bromine atom or an iodine atom); an aryl group (for example, a phenyl group, a p-chlorophenyl group, a mesityl group, a tolyl group, a xylyl group, a biphenyl group, a naphthyl group, an anthryl group, or a phenanthryl group); an alkyl group (for example, a methyl group, an ethyl group, a hydroxyethyl group, a methoxymethyl group, a trifluoromethyl group or a t-butyl group); an alkyloxy group; an aryloxy group; an alkylthio group; an arylthio group; an aromatic hydrocarbon ring (for example, a furyl group, a thienyl group, a pyridyl group, a pyridazinyl group, a pyrimidinyl group, a pyrazinyl group, a triazinyl group, an imidazolyl group, a pyrazolyl group, a thiazolyl group, a quinazolinyl group, a carbazolyl group, a carbolinyl group or a phthalazinyl group); and a group in which M is eliminated from the partial structure represented by formulae (A) to (C).

In formulae (A) to (C), M represents Ir or Pt, and is preferably Ir. A trimer, which is composed of three of the partial structure represented by formula (A) to (C) to form a completed structure, is preferred.

Next, compounds having a partial structure represented by formulae (A) to (C), which are preferably employed as a light emission material, particularly as a phosphorescence emission material, will be listed below, but the invention is not limited thereto.

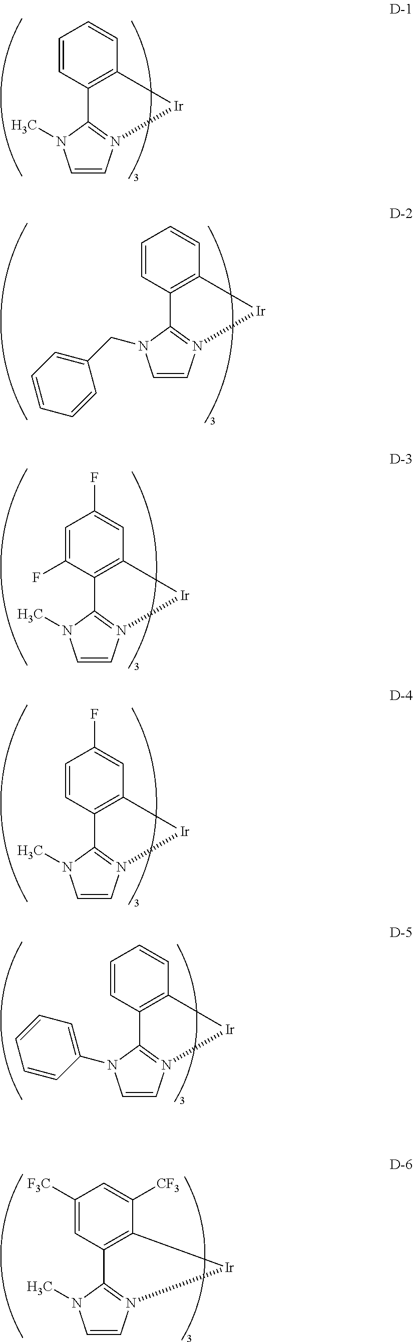

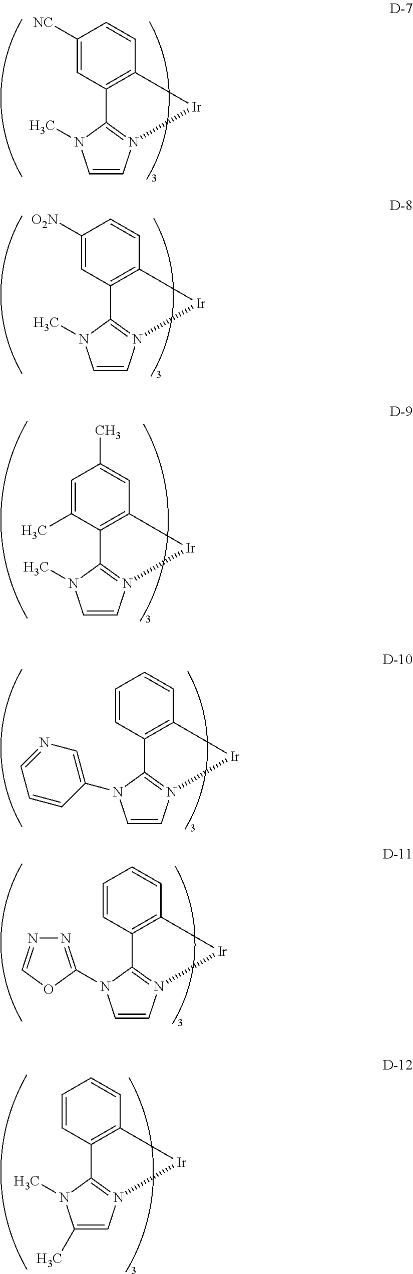

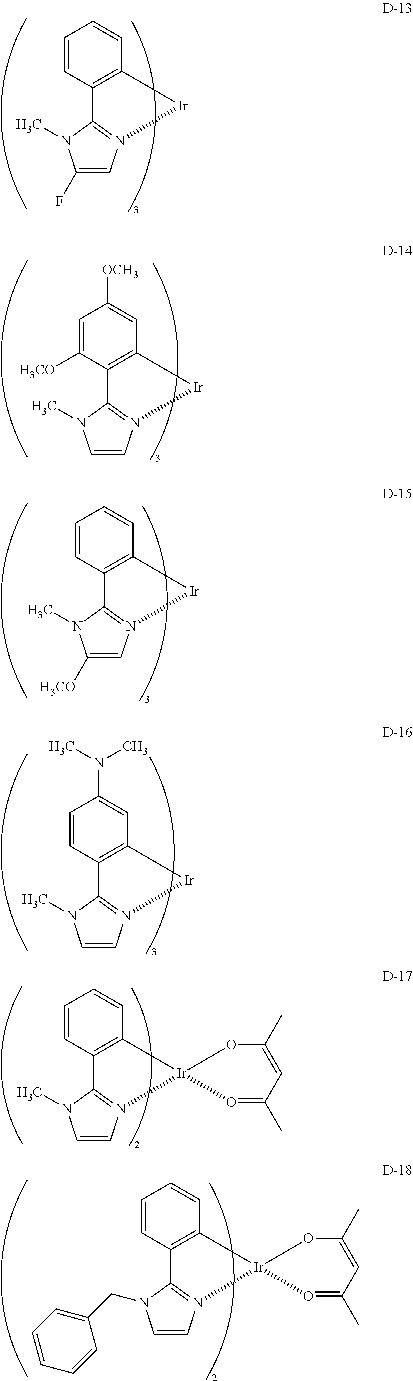

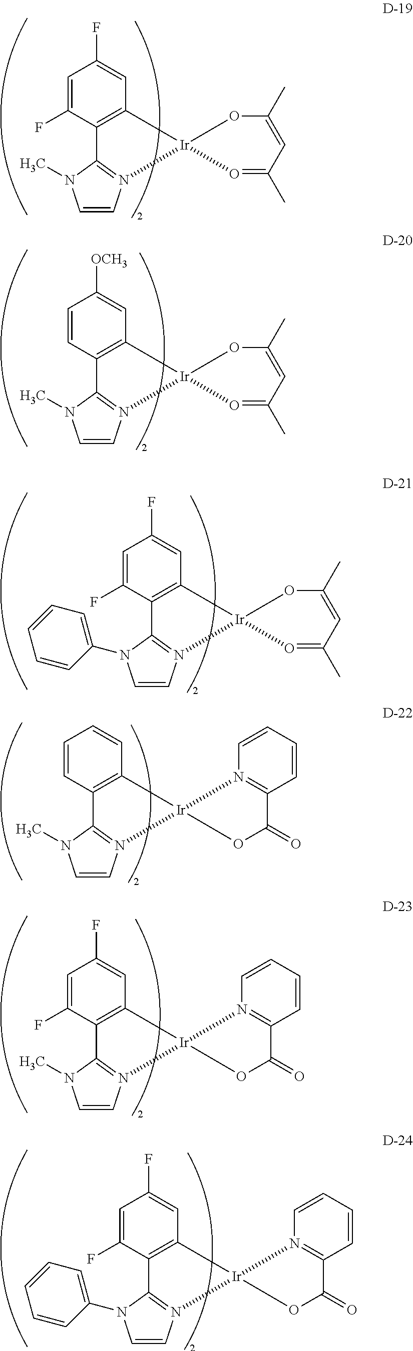

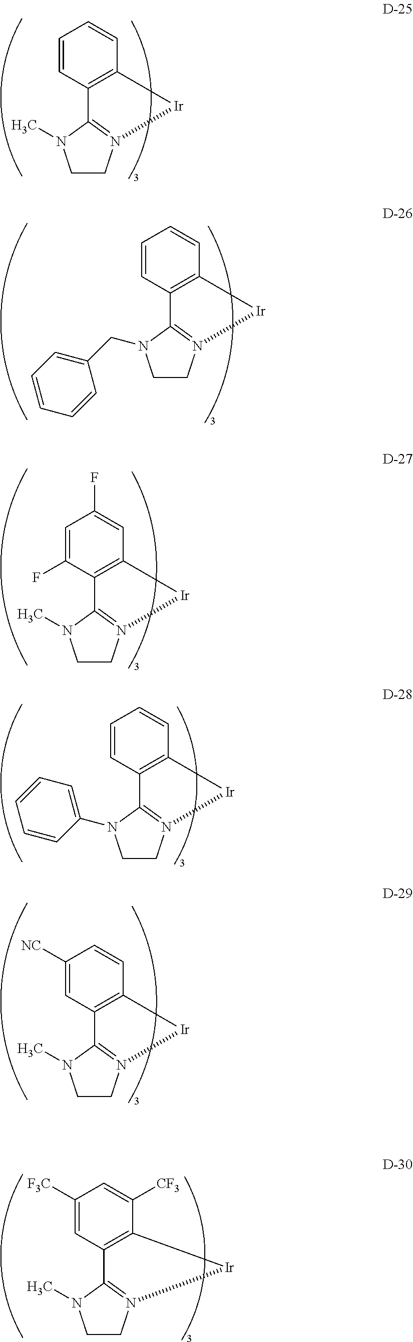

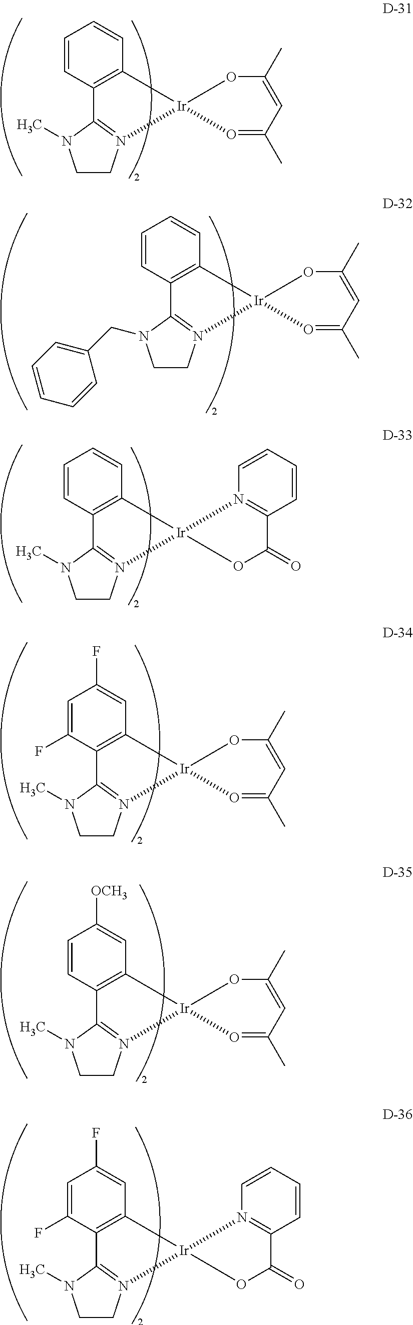

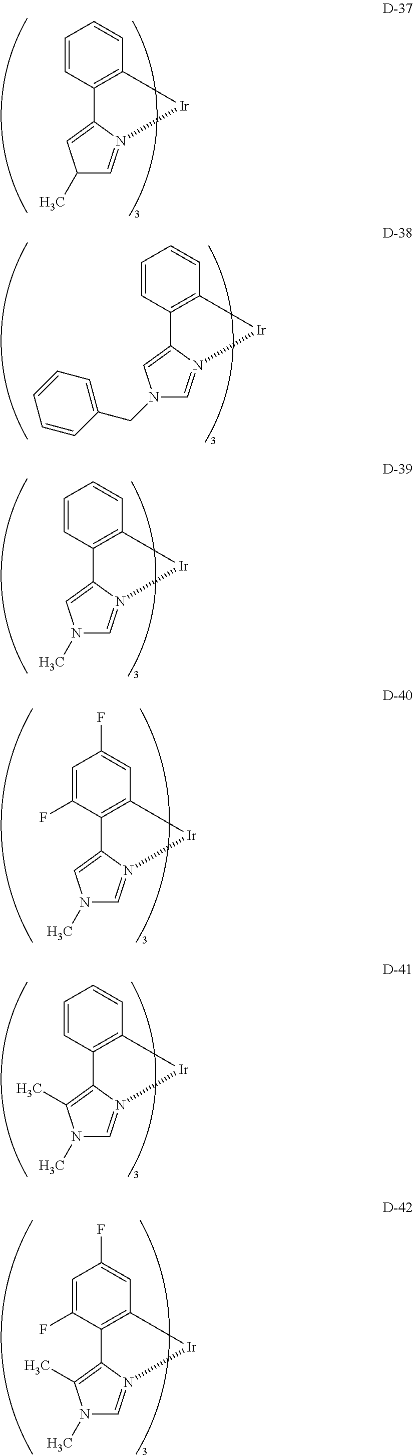

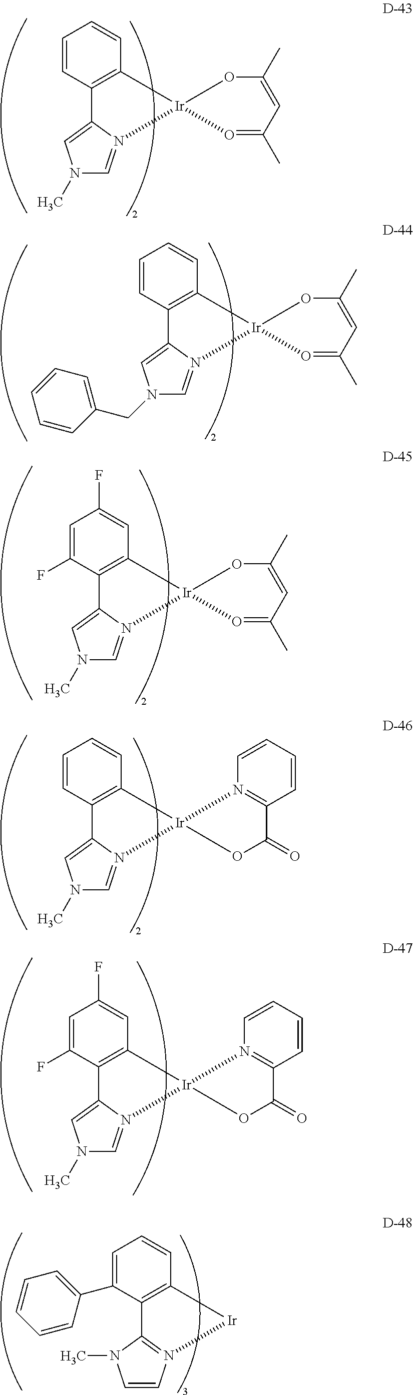

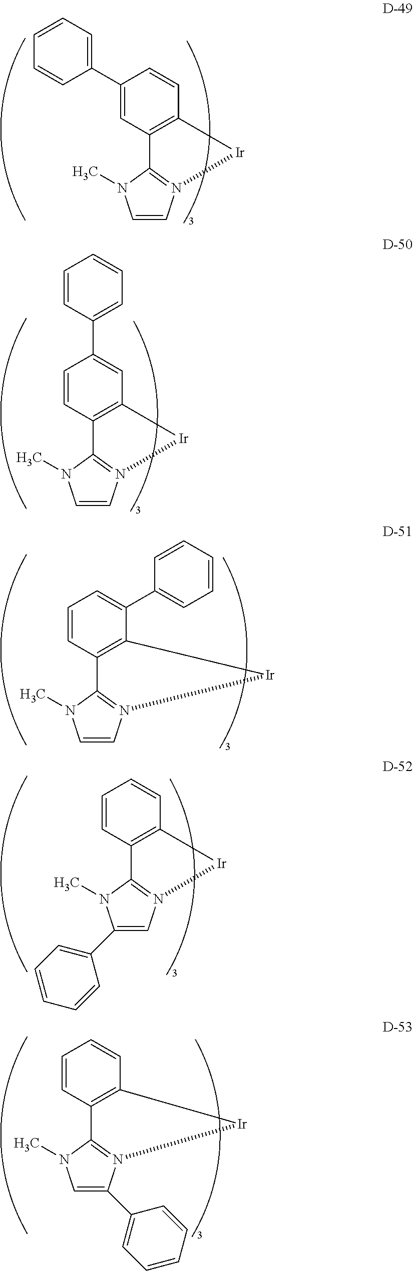

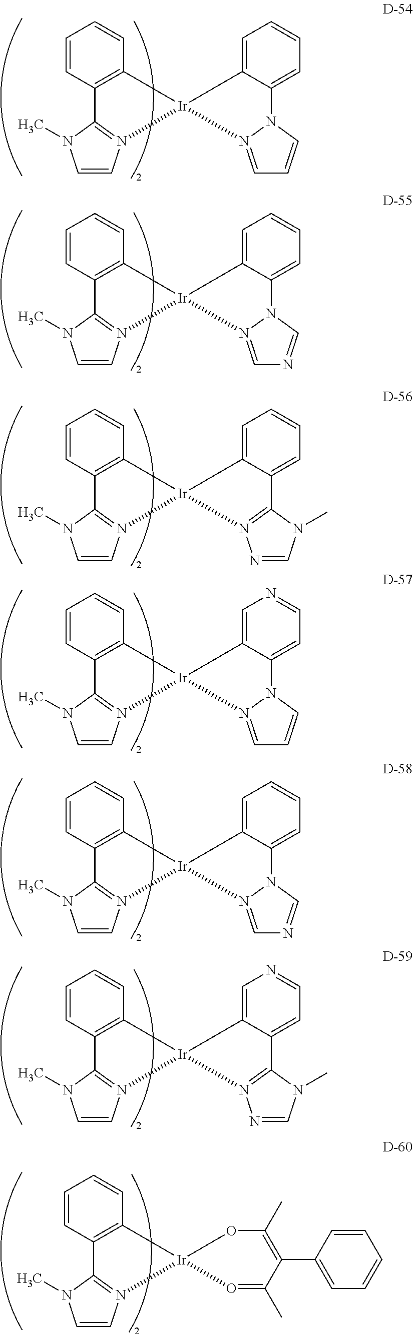

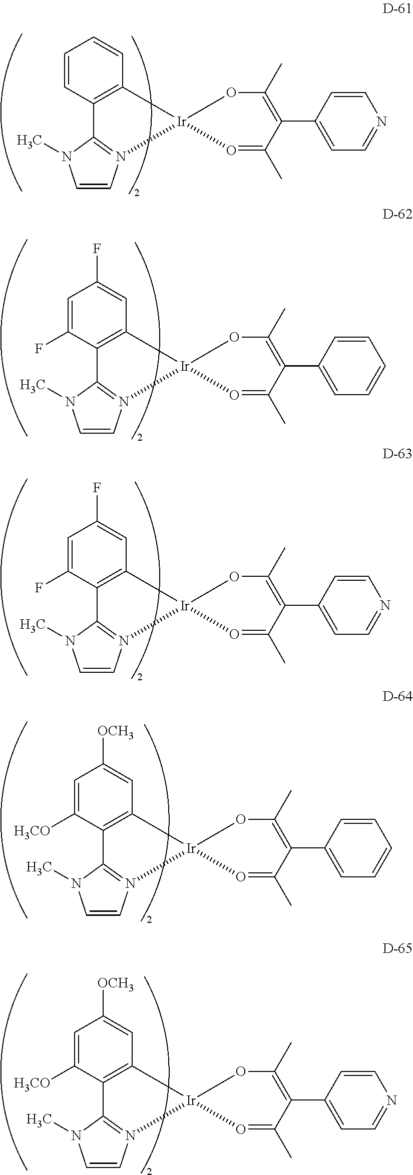

The phosphorescence emission materials (hereinafter also referred to as phosphorescence emission dopants) having any one of the partial structures represented by formulae (A) through (C) can be synthesized according to methods described in for example, Inorg. Chem., Vol. 40, 1704-1711 and the like.

As the phosphorescence emission materials, known compounds as listed below can be employed in combination.

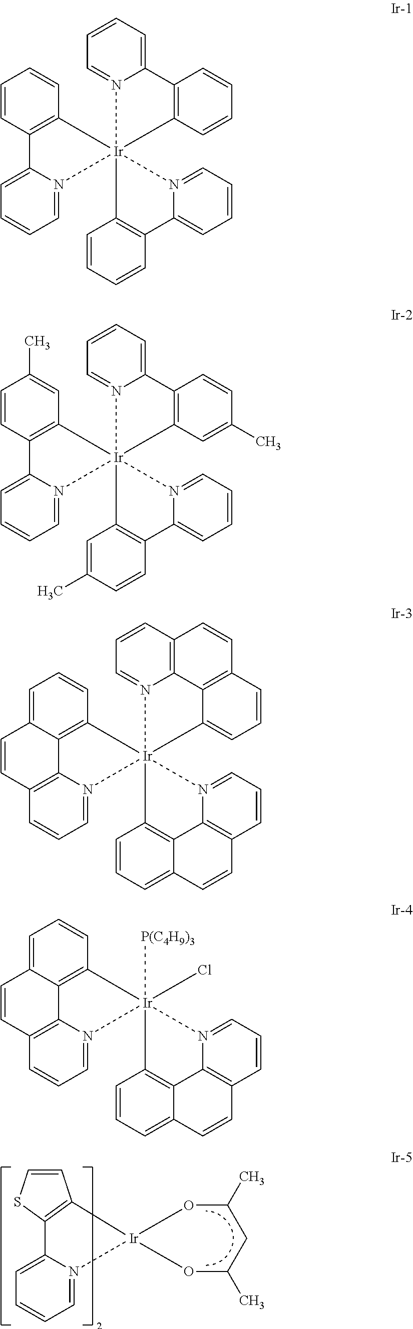

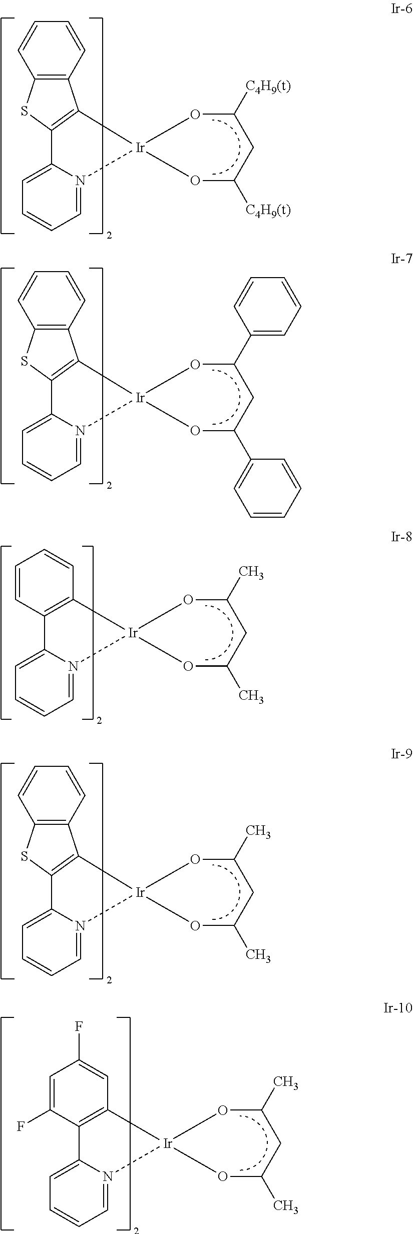

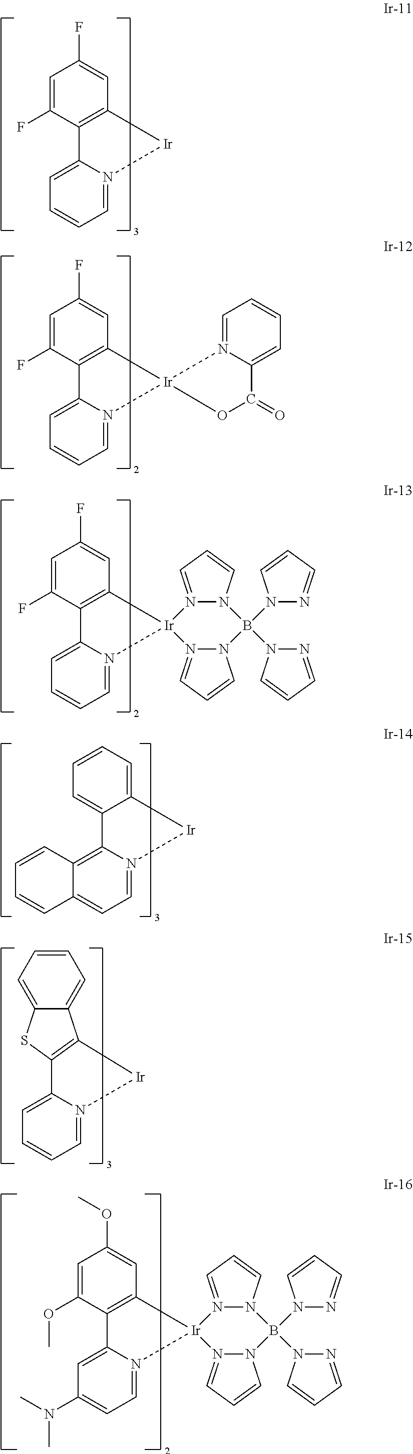

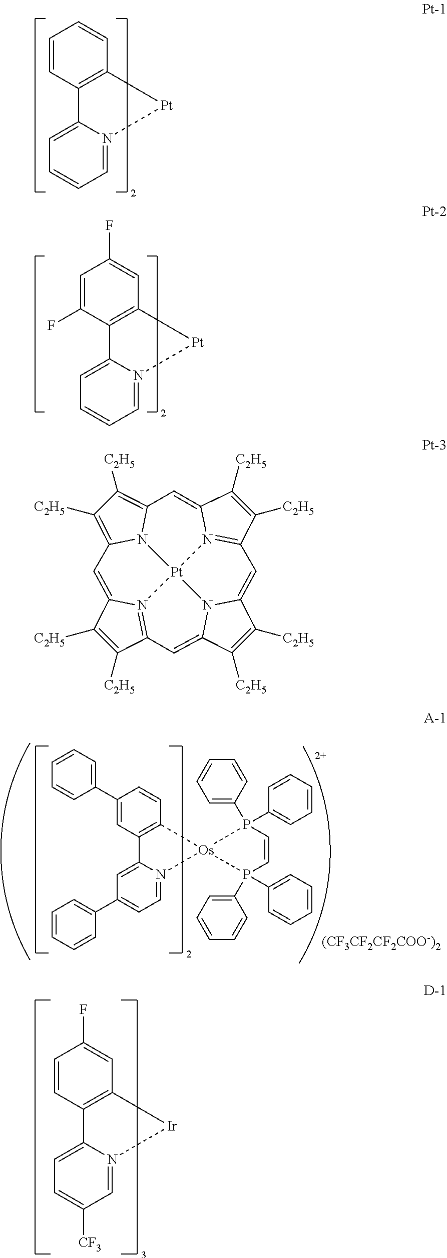

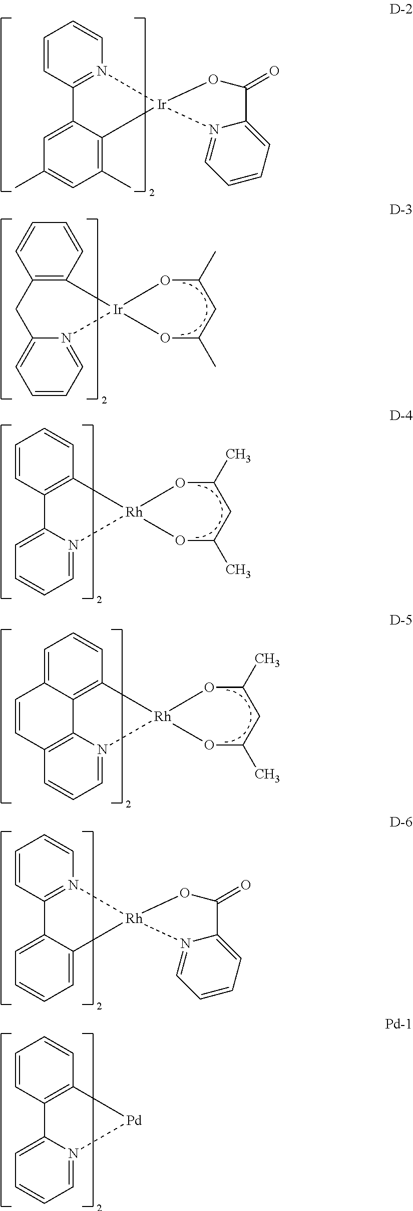

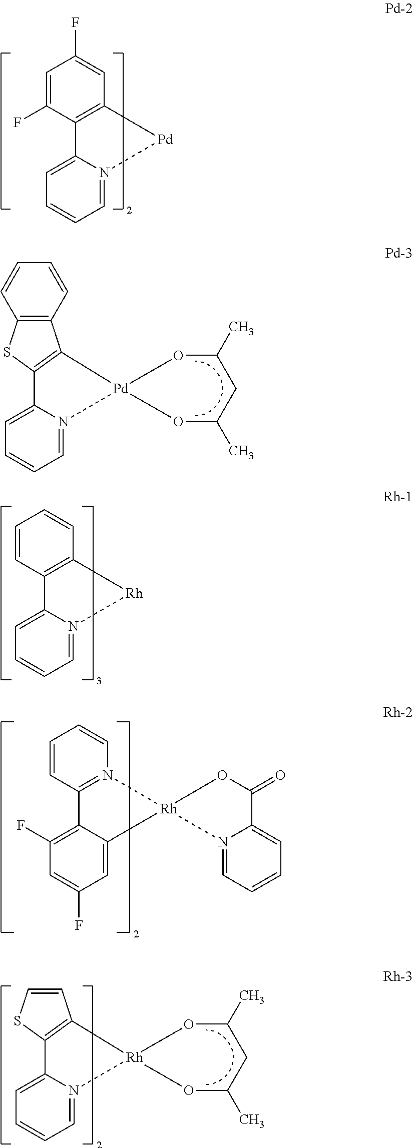

### (Fluorescence Emission Material (Also Referred to as Fluorescence Dopant, Fluorescent Compound))

Examples of the fluorescence emission compound (fluorescent compound) include a coumarin dye, a pyrane dye, a cyanine dye, a croconium dye, a squarylium dye, an oxobenzanthracene dye, a fluorescein dye, a rhodamine dye, a pyrylium dye, a perylene dye, a stilbene dye, a polythiophene dye and rare earth complex type fluorescent compound.

### (Host Compound (Also Referred to as Light Emission Host or Host))

The host compound used in the invention will be explained below.

Herein, the host compound in the invention is defined as a compound which has a phosphorescence quantum yield at room temperature (25° C.) of less than 0.1. The phosphorescence quantum yield of the host compound is preferably less than 0.01. The content of the host compound in the light emission layer is preferably not less than 20% by weight.

As the host compound, known host compounds may be used singly or as an admixture of two or more kinds thereof. Use of plural host compounds can adjust charge transfer, and obtain an organic EL element with high efficiency. Further, use of plural light emission materials described later can mix lights with a different color, and can emit light with any color.

The light emission host used in the invention may be a conventional low molecular weight compound, a polymeric compound having a repeating unit or one or more kinds of a low molecular weight compound (vapor-polymerizable light emission host) with a polymerizable group such as a vinyl group or an epoxy group.

A known host compound, which may be used in combination, is preferably a compound which has a hole transporting capability and an electron transporting capability, prevents shift of a wavelength of emission light to longer wavelength, and has high Tg (glass transition temperature).

Typical examples of the known host compounds include those described in the following documents.

For example, Japanese Patent O.P.I. Publication Nos. 2001-257076, 2002-308855, 2001-313179, 2002-319491, 2001-357977, 2002-334786, 2002-8860, 2002-334787, 2002-15871, 2002-334788, 2002-43056, 2002-334789, 2002-75645, 2002-338579, 2002-105445, 2002-343568, 2002-141173, 2002-352957, 2002-203683, 2002-363227, 2002-231453, 2003-3165, 2002-234888, 2003-27048, 2002-255934, 2002-260861, 2002-280183, 2002-299060, 2002-302516, 2002-305083, 2002-305084 and 2002-308837.

Next, an injecting layer, a blocking layer, and an electron transporting layer used in the constituent layer of the organic EL element of the invention will be explained.

### <<Injecting Layer: Electron Injecting Layer, Hole Injecting Layer>>

The injecting layer, for example, an electron injecting layer or a hole injecting layer, is optionally provided, and may be provided between the anode and the light emission layer or hole transporting layer, and between the cathode and the light emission layer or electron transporting layer, as described above.

The injecting layer herein referred to is a layer provided between the electrode and an organic layer in order to reduce the driving voltage or to improve of light emission efficiency, which is detailed in “Electrode Material”, Div. 2 Chapter 2, pp. 123-166 of “Organic EL element and its frontier of industrialization” (published by NTS Corporation, Nov. 30, 1998). As the injecting layer there are a hole injecting layer (an anode buffer layer) and an electron injecting layer (a cathode buffer layer).

The anode buffer layer (hole injecting layer) is described in Japanese Patent O.P.I. Publication Nos. 9-45479, 9-260062, and 8-288069 etc., and its examples include a phthalocyanine buffer layer represented by a copper phthalocyanine layer, an oxide buffer layer represented by a vanadium oxide layer, an amorphous carbon buffer layer, a polymer buffer layer employing an electroconductive polymer such as polyaniline (emeraldine), and polythiophene, etc.

The cathode buffer layer (electron injecting layer) is described in Japanese Patent O.P.I. Publication Nos. 6-325871, 9-17574, and 10-74586, etc. in detail, and its examples include a metal buffer layer represented by a strontium or aluminum layer, an alkali metal compound buffer layer represented by a lithium fluoride layer, an alkali earth metal compound buffer layer represented by a magnesium fluoride layer, and an oxide buffer layer represented by an aluminum oxide. The buffer layer (injecting layer) is preferably very thin and has a thickness of preferably from 0.1 nm to 5 μm depending on kinds of the material used.

### <<Blocking Layer: Hole Blocking Layer, Electron Blocking Layer>>

The blocking layer is a layer provided if necessary in addition to the fundamental constituent layer as described above, and is for example a hole blocking layer as described in Japanese Patent O.P.I. Publication Nos. 11-204258, and 11-204359, and on page 237 of “Organic EL element and its frontier of industrialization” (published by NTS Corporation, Nov. 30, 1998).

The hole blocking layer is an electron transporting layer in a broad sense, and is comprised of material having an ability of transporting electrons but an extremely poor ability of holes, which can increase a recombination probability of electrons and holes by transporting electrons and blocking holes. Further, the constitution of an electron transporting layer described later can be used in the hole blocking layer in the invention as necessary.

The hole blocking layer in the organic EL element of the invention is preferably provided to be in contact with a light emission layer.

It is preferred that the hole blocking layer contains an azacarbazole derivative described above as the host compound.

Further, in the invention, when there are a plurality of light emission layers which emit a plurality of different color lights, it is preferable that a light emission layer which emits a light having emission maximum in the shortest wavelength of all the light emission layers is provided closest to the anode. In such a case, it is preferred that a hole blocking layer is additionally provided between the above light emission layer which emits a light having emission maximum in the shortest wavelength and a light emission layer which is provided closest to the anode, except for the above layer.

Further, it is preferred that at least 50% by weight of compounds, which are incorporated in the hole blocking layer arranged in the above position, has an ionization potential 0.3 eV higher than that of the host compound contained in the light emission layer which emits a light having emission maximum in the shortest wavelength.

Ionization potential is defined as energy required to transfer an electron in the highest occupied molecular orbital to the vacuum level, and can be determined by the methods described below:

(1) The ionization potential can be obtained as a value obtained by rounding to one decimal a value (in terms of eV), which is calculated by performing structural optimization employing Gaussian 98 (Gaussian 98, Revision A. 11.4, M J. Frisch, et al., Gaussian, Inc., Pittsburgh Pa., 2002), which is a software for molecular orbital calculation of Gaussian, Inc., and B3LYP/6-31G* as a key word, and the calculated value (being the value in terms of eV unit) is rounded off at the second decimal place. Background in which the calculated value above is effective is that the calculated value obtained by the above method and experimental values exhibit high correlation.

(2) It is also possible to obtain ionization potential via a direct measurement method employing a photoelectron spectroscopy. For example, it is possible to appropriately employ a low energy electron spectrometer “Model AC-1”, produced by Riken Keiki Co., Ltd., or a method known as ultraviolet photoelectron spectroscopy.

On the other hand, the electron blocking layer is a hole transporting layer in a broad sense, and is comprised of material having an ability of transporting holes but an extremely poor ability of electrons, which can increase a recombination probability of electrons and holes by transporting holes and blocking electrons. The constitution of the hole transporting layer as described later can be used as that of the electron blocking layer. The thickness of the hole blocking layer or electron transporting layer is preferably from 3 nm to 100 nm, and more preferably from 5 nm to 30 nm.

### <<Hole Transporting Layer>>

The hole transporting layer is comprised of a hole transporting material having an ability of transporting holes, and a hole injecting layer and an electron blocking layer are included in the hole transporting layer in a broad sense. The hole transporting layer may be a single layer or plural layers.

The hole transporting material has a hole injecting ability, a hole transporting ability or an ability to form a barrier to electrons, and may be either an organic substance or an inorganic substance. Examples of thereof include a triazole derivative, an oxadiazole derivative, an imidazole derivative, a polyarylalkane derivative, a pyrazoline derivative and a pyrazolone derivative, a phenylenediamine derivative, an arylamine derivative, an amino substituted chalcone derivative, an oxazole derivative, a styryl anthracene derivative, a fluorenone derivative, a hydrazone derivative, a stilbene derivative, a silazane derivative, an aniline copolymer, and an electroconductive oligomer, particularly a thiophene oligomer.

As the hole transporting material, those described above are used, but a porphyrin compound, an aromatic tertiary amine compound, or a styrylamine compound is preferably used, and an aromatic tertiary amine compound is more preferably used.

Typical examples of the aromatic tertiary amine compound and styrylamine compound include N,N,N′,N′-tetraphenyl-4,4′-diaminophenyl, N,N′-diphenyl-N,N′-bis(3-methylphenyl)-[1,1′-biphenyl]-4,4′-diamine(TPD), 2,2′-bis(4-di-p-tolylaminophenyl)propane, 1,1-bis(4-di-p-tolylaminophenyl)cyclohexane, N,N,N′,N′-tetra-p-tolyl-4,4′-diaminobiphenyl, 1,1-bis(4-di-p-tolylaminophenyl)-4-phenylcyclohexane, bis(4-dimethylamino-2-methylphenyl)-phenylmethane, bis(4-di-p-tolylaminophenyl)phenylmethane, N,N′-diphenyl-N,N′-di(4-methoxyphenyl)-4,4′-diaminobiphenyl, N,N,N′,N′-tetraphenyl-4,4′-diaminodiphenyl ether, 4,4′-bis(diphenylamino)quardriphenyl, N,N,N-tri(p-tolyl)amine, 4-(di-p-tolylamino)-4′-[4-(di-p-tolylamino)styryl]stilbene, 4-N,N-diphenylamino(2-diphenylvinyl)benzene, 3-methoxy-4′-N,N-diphenylaminostylbenzene, N-phenylcarbazole, compounds described in U.S. Pat. No. 5,061,569 which have two condensed aromatic rings in the molecule thereof such as 4,4′-bis[N-(1-naphthyl)-N-phenylamino]biphenyl (NPD), and compounds described in Japanese Patent O.P.I. Publication No. 4-308688 such as 4,4′,4″-tris[N-(3-methylphenyl)-N-phenylamino]-triphenylamine (MTDATA) in which three triphenylamine units are bonded in a starburst form.

A polymer in which the material mentioned above is introduced in the polymer chain or a polymer having the material as the polymer main chain can be also used. As the hole injecting material or the hole transporting material, inorganic compounds such as p-type-Si and p-type-SiC are usable.

So-called p-type hole transporting materials as disclosed in JP-A No. 11-251067 or described in the literature of J. Huang et al. (Applied Physics Letters 80 (2002), p. 139) are also applicable. In the present invention, these materials are preferably utilized since an emitting element exhibiting a higher efficiency is obtained.

The hole transporting layer can be formed by layering the hole transporting material by a known method such as a vacuum deposition method, a spin coat method, a casting method, an ink jet method, and an LB method. The thickness of the hole transporting layer is not specifically limited, but is ordinarily from 5 nm to 5 μm, and preferably from 5 to 200 nm. The hole transporting layer may be composed of a single layer structure comprising one or two or more of the materials mentioned above.

A positive hole transporting layer having high p-type property doped with impurity can be utilized. Examples thereof include those described in Japanese Patent O.P.I. Publication Nos. 4-297076, 2000-196140 and 2001-102175, and J. Appl. Phys., 95, 5773 (2004), and so on.

It is preferable in the invention to employ such a positive hole transporting layer having high p-type property, since an element with lower power consumption can be prepared.

### <<Electron Transporting Layer>>

The electron transporting layer comprises a material (an electron transporting material) having an electron transporting ability, and in a broad sense refers to an electron injecting layer or a hole blocking layer. The electron transporting layer can be provided as a single layer or plural layers.

An electron transporting material (which serves also as a hole blocking material) used in a single electron transporting layer or in the electron transporting layer closest to the cathode of plural electron transporting layers has a function of incorporating electrons injected from a cathode to a light emission layer, and can be selected from known compounds. Examples thereof include a nitro-substituted fluorene derivative, a diphenylquinone derivative, a thiopyran dioxide derivative, a carbodiimide, a fluolenylidenemethane derivative, an anthraquinodimethane, an anthrone derivative, and an oxadiazole derivative.

Moreover, a thiadiazole derivative which is formed by substituting the oxygen atom in the oxadiazole ring of the foregoing oxadiazole derivative with a sulfur atom, and a quinoxaline derivative having a quinoxaline ring known as an electron withdrawing group are usable as the electron transporting material. A polymer in which the material mentioned above is introduced in the polymer side chain or a polymer having the material as the polymer main chain can be also used.

A metal complex of an 8-quinolynol derivative such as aluminum tris-(8-quinolynol) (Alq₃), aluminum tris-(5,7-dichloro-8-quinolynol), aluminum tris-(5,7-dibromo-8-quinolynol), aluminum tris-(2-methyl-8-quinolynol), aluminum tris-(5-methyl-8-quinolynol), or zinc bis-(8-quinolynol) (Znq₂), and a metal complex formed by replacing the central metal of the foregoing complexes with another metal atom such as In, Mg, Cu, Ca, Sn, Ga or Pb, can be used as the electron transporting material.

Furthermore, a metal free or metal-containing phthalocyanine, and a derivative thereof, in which the molecular terminal is replaced by a substituent such as an alkyl group or a sulfonic acid group, are also preferably used as the electron transporting material.

The distyrylpyrazine derivative exemplified as a material for the light emission layer may preferably be employed as the electron transporting material. An inorganic semiconductor such as n-type-Si and n-type-SiC may also be used as the electron transporting material in a similar way as in the hole injecting layer or in the hole transporting layer.

The electron transporting layer can be formed employing the above-described electron transporting materials and a known method such as a vacuum deposition method, a spin coat method, a casting method, a printing method including an ink jet method or an LB method.

The thickness of the electron transporting layer is not specifically limited, but is ordinarily from 5 nm to 5 μm, and preferably from 5 to 200 nm. The electron transporting layer may be composed of a single layer comprising one or two or more of the electron transporting material.

An electron transporting layer having high n property doped with impurity can be utilized. Examples thereof include those described in Japanese Patent O.P.I. Publication Nos. 4-297076, 10-270172, 2000-196140, 2001-102175, and J. Appl. Phys., 95, 5773 (2004), and so on.

It is preferred in the invention that use of such an electron transport layer having high n property can provide an element with lower power consumption.

### Polymerization Cross-Linking Material for Organic EL Element (Also Referred to as Material for Reactive Organic EL Element)

In the invention, an organic compound having a reactive group (also referred to as a reactive organic compound), which is capable of being polymerization cross-linked after having been coated, can be employed as a polymerization cross-linking material for an organic EL element. A layer, in which the polymerization cross-linking material for an organic EL element (a reactive material for an organic EL element) is contained, is not specifically limited and may be any layer.

The reactive material for an organic EL element is polymerization cross-linked on the substrate to form a layer composed of a network polymer of an organic molecule. The Tg (glass transition temperature) of the layer can be adjusted by the formation of the network polymer, whereby deterioration of the element can be prevented.

The emission wavelength of the organic EL element can be varied or deterioration of light with a specific wavelength can be prevented by adjusting reaction accompanied by cleavage or generation of the conjugated bond employing active radicals used in the element.

In the method of manufacturing the element, for example, when plural organic layers are laminate coated, a lower layer is preferably insoluble in an upper layer coating solution, and an upper layer coating solution can be applied onto a lower layer subjected to polymerization cross-linking processing to decrease the solubility.

The glass transition temperature (Tg) is a value which is determined according to the method specified in JIS K 7121, employing DSC (Differential Scanning calorimetry).

Examples of the reactive group used in the invention will be listed below.

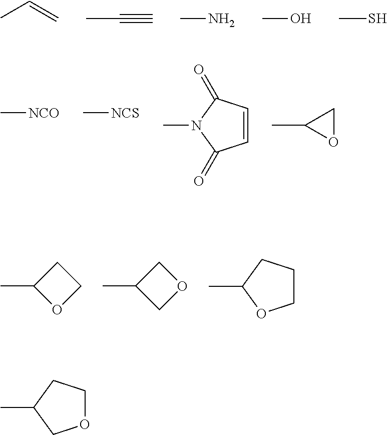

Typical examples of the polymerization cross-linking material for an organic EL element used in the invention will be listed below, but the invention is not limited thereto.

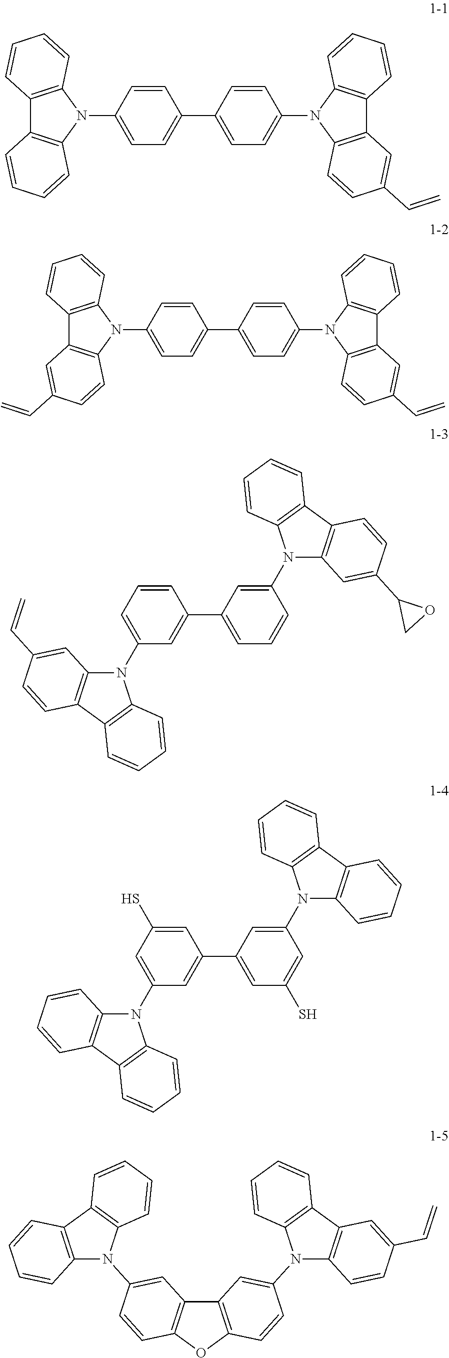

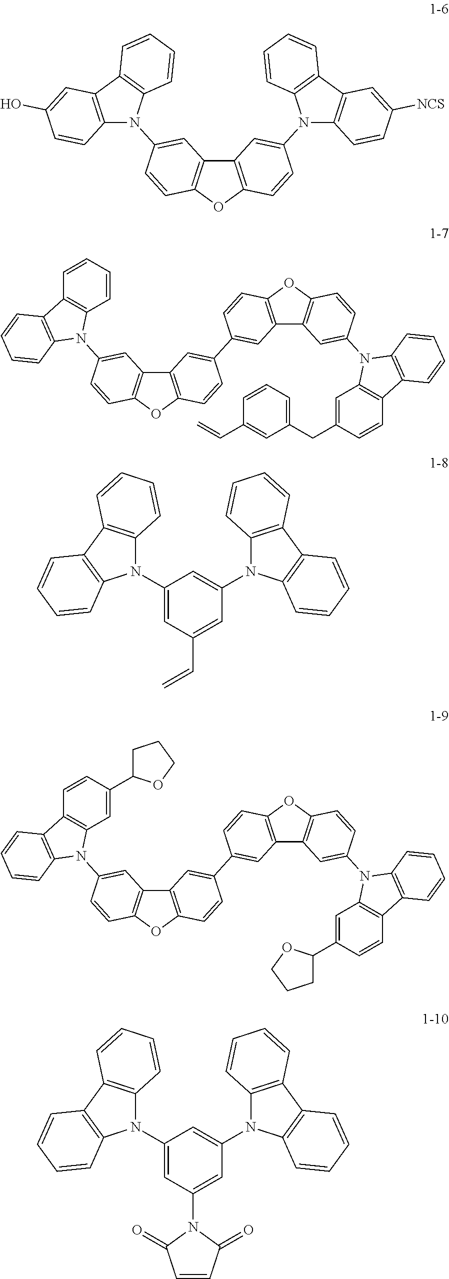

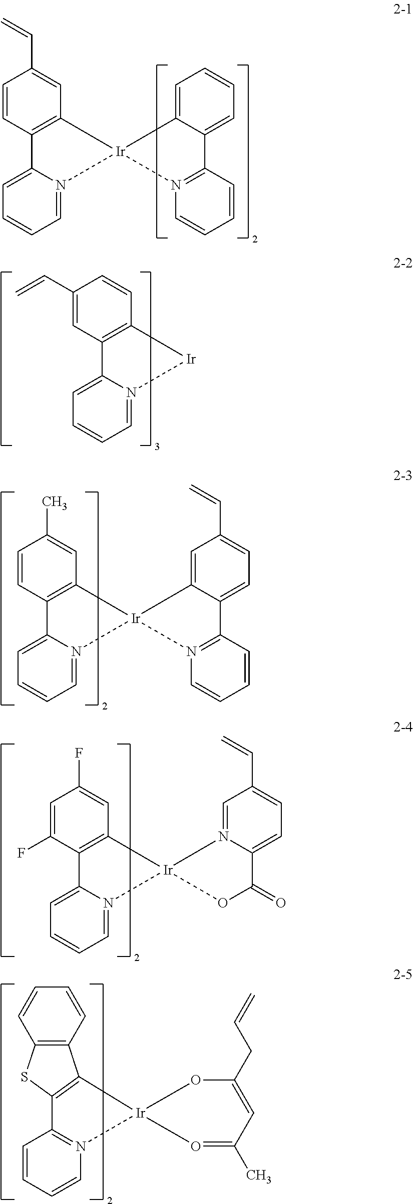

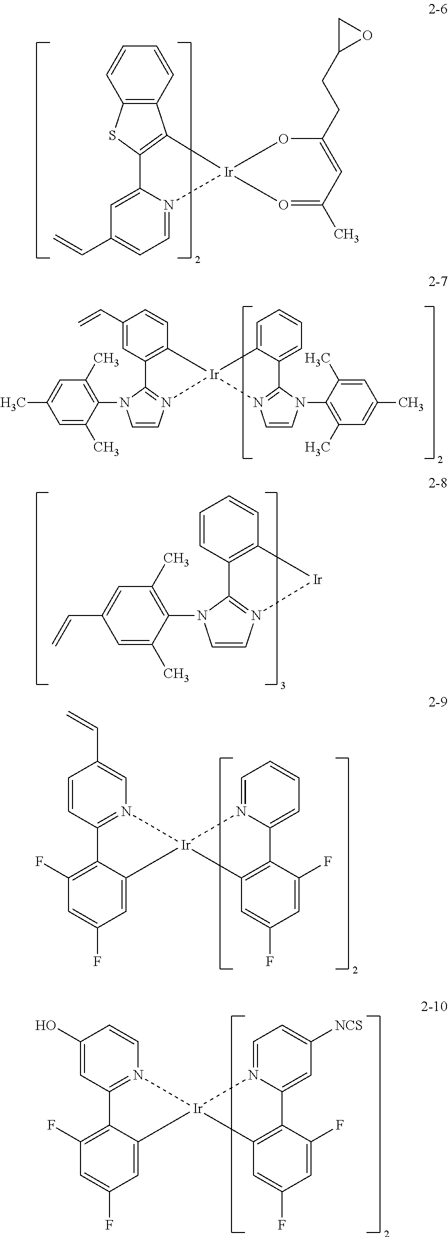

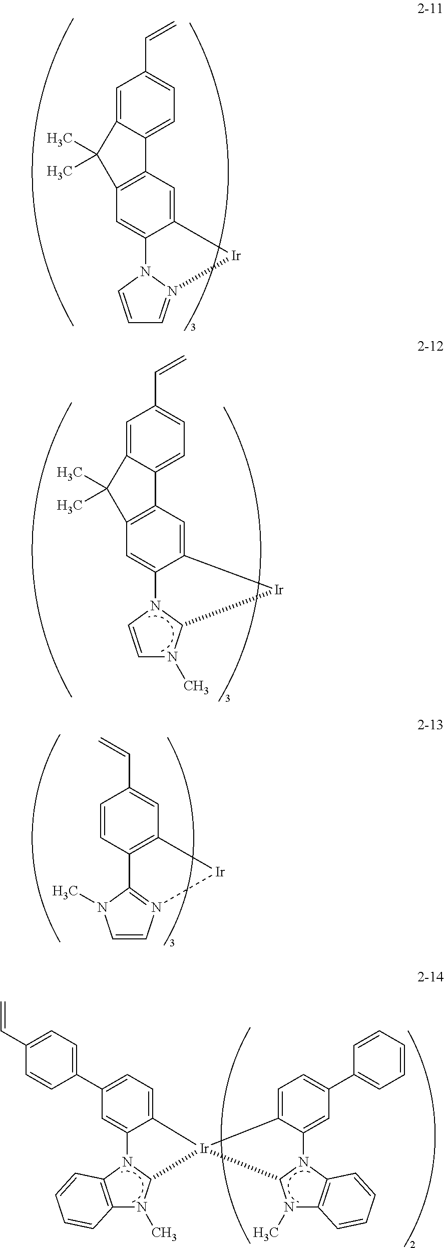

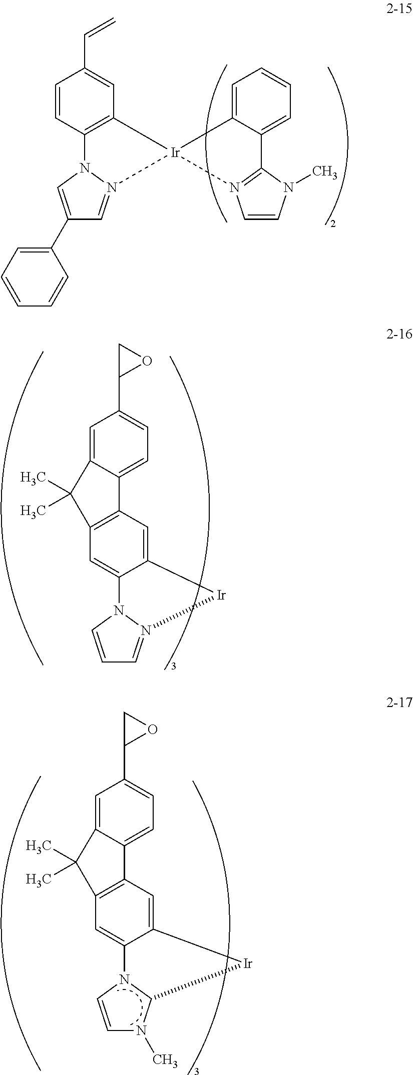

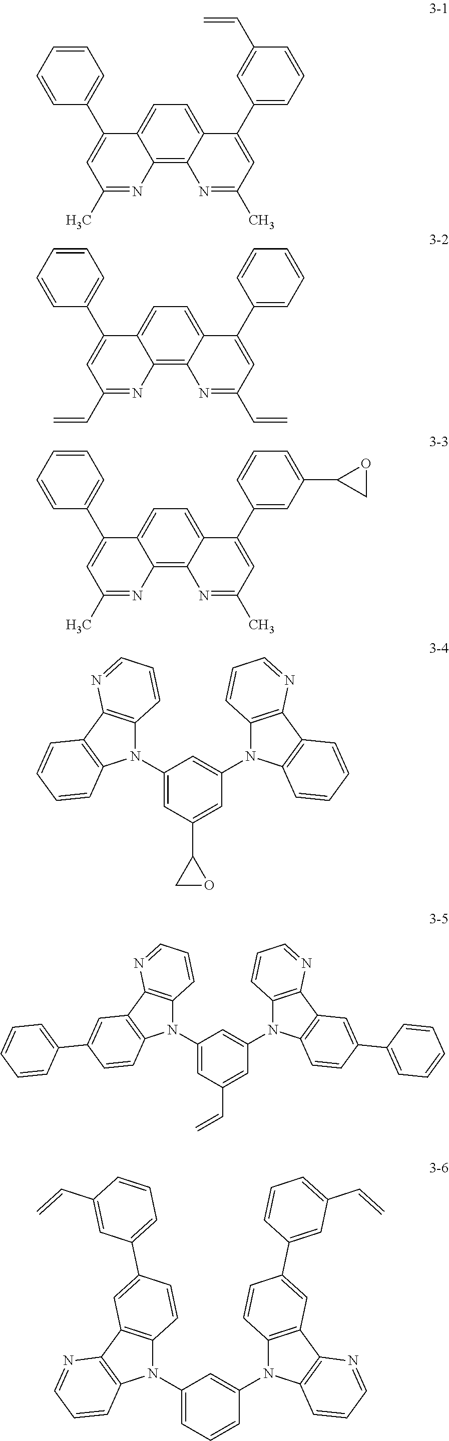

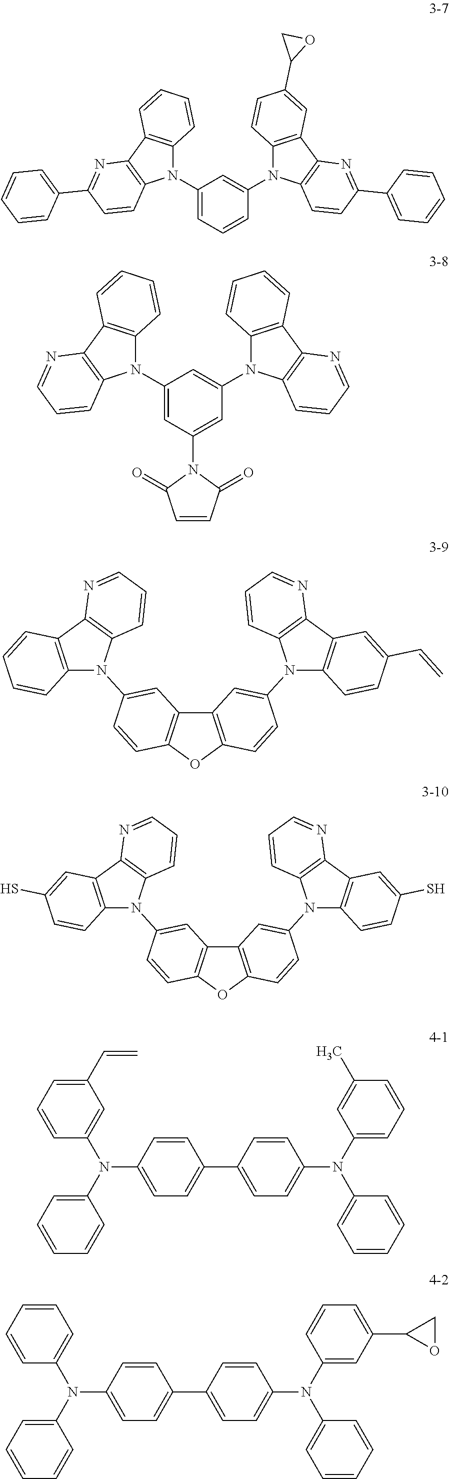

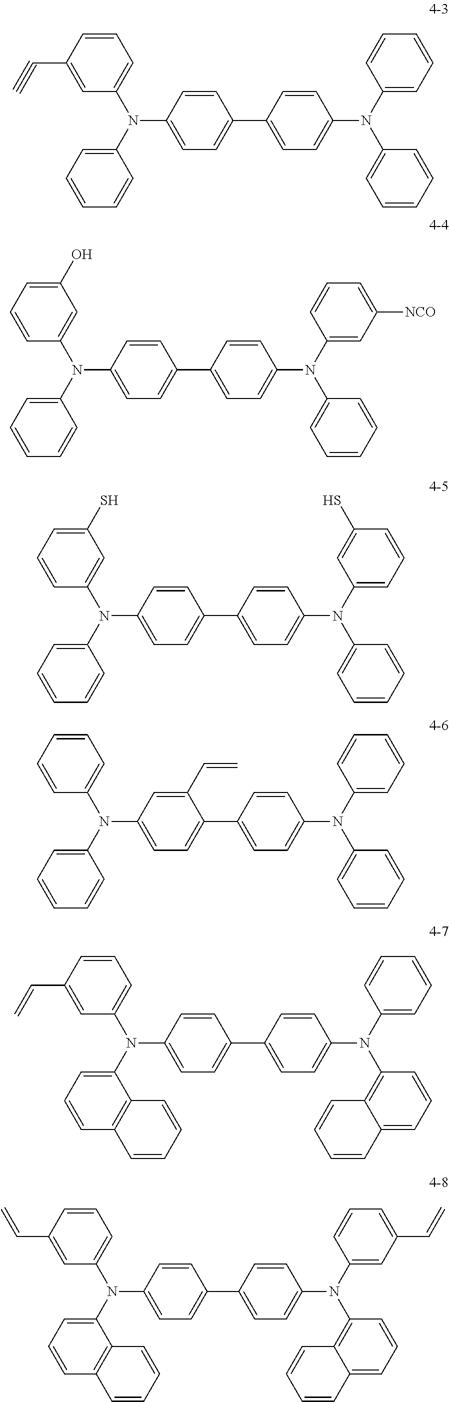

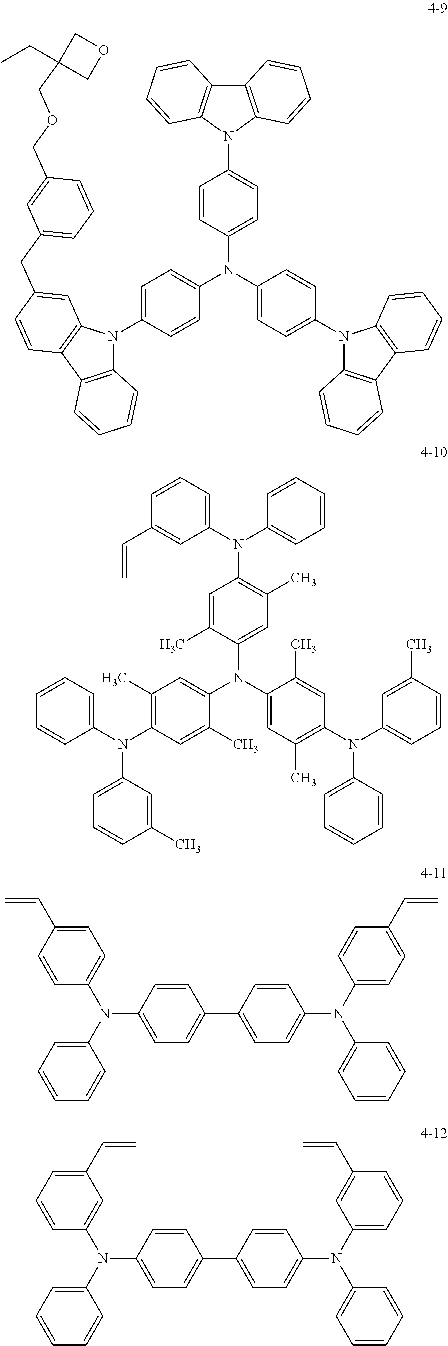

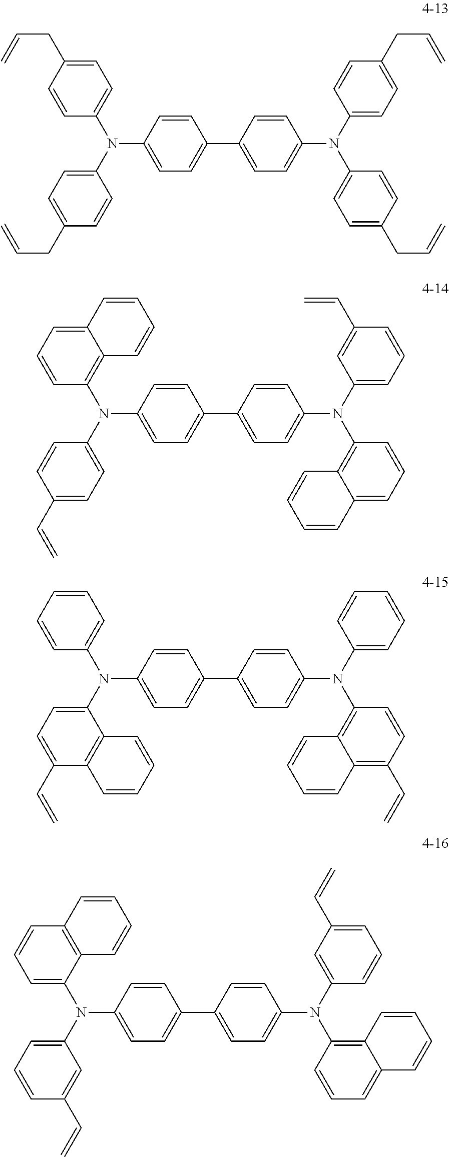

The polymerization cross-linking material for an organic EL element described above can be synthesized according to a method described in for example, “SHIN KOBUNSHI JIKKENGAKU 2 KOBUNSHI NO GOSEI·HAN-NO” (KYORITSU SHUPPAN CO., LTD.).

### (Polymerization Cross-Linking Method of Polymerization Cross-Linking Material for Organic EL Element)

As a polymerization cross-linking method of the polymerization cross-linking material for the organic EL element, there can be used various energy rays. Examples of the energy rays include X-rays, neutron ray, electron beam and ultraviolet ray, and ultraviolet ray or electron beam is preferred.

Examples of an ultraviolet ray source include an ultraviolet lamp (for example, low pressure, medium pressure or high pressure mercury lamp with a operating pressure of from 0.5 kPa to 1 MPa), a xenon lamp, a tungsten lamp, and a halogen lamp. The intensity of the ultraviolet ray is preferably from 1 mW/cm² to 500 mW/cm².

Energy necessary for polymerization crosslinking (also referred to as curing) is preferably from 0.01 kJ/cm² to 30 kJ/cm².

### <<Anode>>

For the anode of the organic EL element, a metal, an alloy, or an electroconductive compound each having a high working function (not less than 4 eV), and mixture thereof are preferably used as the electrode material. Typical examples of such an electrode material include a metal such as Au, and a transparent electroconductive material such as CuI, indium tin oxide (ITO), SnO₂ or ZnO. A material such as IDIXO (In₂O₃—ZnO) capable of forming an amorphous and transparent conductive layer may be used.

The anode may be prepared by forming a thin layer of the electrode material according to a depositing or spattering method, and by forming the layer into a desired pattern according to a photolithographic method. When required precision of the pattern is not so high (not less than 100 μm), the pattern may be formed by depositing or spattering of the electrode material through a mask having a desired form.

When a coatable material such as an organic conductive compound is used, a wet coating method such as a printing method or a coating method can be used. When light is emitted through the anode, the transmittance of the anode is preferably 10% or more, and the sheet resistance of the anode is preferably not more than several hundreds Ω/□.

The thickness of the layer is ordinarily within the range of from 10 nm to 1000 nm, and preferably from 10 nm to 200 nm, although it may vary due to kinds of materials used.

### <<Cathode>>

For the cathode, a metal (also referred to as an electron injecting metal), an alloy, and an electroconductive compound each having a low working function (not more than 4 eV), and a mixture thereof is used as the electrode material.

Concrete examples of such an electrode material include sodium, sodium-potassium alloy, magnesium, lithium, a magnesium/copper mixture, a magnesium/silver mixture, a magnesium/aluminum mixture, magnesium/indium mixture, an aluminum/aluminum oxide (Al₂O₃) mixture, indium, a lithium/aluminum mixture, and a rare-earth metal.

Among them, a mixture of an electron injecting metal and a metal higher in the working function than that of the electron injecting metal, such as the magnesium/silver mixture, magnesium/aluminum mixture, magnesium/indium mixture, aluminum/aluminum oxide (Al₂O₃) mixture, lithium/aluminum mixture, or aluminum is suitable from the view point of the electron injecting ability and resistance to oxidation.

The cathode can be prepared forming a thin layer of such an electrode material by a method such as a deposition or spattering method. The sheet resistance as the cathode is preferably not more than several hundreds Ω/□, and the thickness of the layer is ordinarily from 10 nm to 5 μm, and preferably from 50 nm to 200 nm.

It is preferred in increasing emission luminance that either the anode or the cathode of the organic EL element, through which light passes, is transparent or semi-transparent.

After a layer of the metal described above as a cathode is formed to give a thickness of from 1 nm to 20 nm, a layer of the transparent electroconductive material as described in the anode is formed on the resulting metal layer, whereby a transparent or semi-transparent cathode can be prepared. Employing this cathode, an element can be manufactured in which both anode and cathode are transparent.

### <<Substrate>>

The substrate (also referred to as a base body, a base material, a supporting substrate or a support) employed for the organic EL element of the invention is not restricted to specific kinds of materials such as glass and plastic, as far as it is transparent. When light is taken out from the substrate side, the substrate is preferably transparent. Examples of the substrate preferably used include glass, quartz and light transmissible plastic film. Especially preferred one is a resin film capable of providing flexibility to the organic EL element.

Examples of materials for the resin film include polyesters such as polyethylene terephthalate (PET) and polyethylene naphthalate (PEN), polyethylene, polypropylene, cellophane, cellulose esters and their derivatives such as cellulose diacetate, cellulose triacetate, cellulose acetate butylate, cellulose acetate propionate (CAP), cellulose acetate phthalate (TAC), and cellulose nitrate, polyvinylidene chloride, polyvinylalcohol, polyethylenevinylalcohol, syndiotactic polystyrene, polycarbonate, norbornane resin, polymethylpentene, polyetherketone, polyimide, polyether sulfone (PES), polyphenylene sulfide, polysulfones, polyether imide, polyetherketone imide, polyamide, fluorine resin, nylon, polymethyl methacrylate, acryl or polyarylates, and cyclo-olefin resins such as ARTON (commercial name, manufactured by JSR Corp.) or APEL (commercial name, manufactured by Mitsui Chemicals Inc.).

On the surface of the resin film, an inorganic or organic cover film or a hybrid cover film comprising the both may be formed, and the cover film is preferably one with a bather ability having a vapor permeability (at 25±0.5° C. and at (90±2) % RH) of not more than 0.01 g/(m²·24 h) measured by a method stipulated by JIS K 7129-1992, and more preferably one with a high barrier ability having an oxygen permeability of not more than 10 ml/(m²·24 hr·MPa) as well as a vapor permeability of not more than 10 g/(m²·24 h), measured by a method stipulated by JIS K 7126-1987.

Any materials capable of preventing penetration of substance such as moisture and oxygen causing degradation of the element are usable for forming the bather film, and for example, silicon oxide, silicon dioxide and silicon nitride are usable.

It is more preferred that the bather film has a multi-laminated layer structure composed of a layer of the inorganic material and a layer of an organic material for improving fragility of the film. It is preferred that the both layers are alternatively laminated several times though there is no limitation as to the lamination order of the inorganic layer and the organic layer.

The method for forming the barrier film is not specifically limited and, for example, a vacuum deposition method, a spattering method, a reaction spattering method, a molecule beam epitaxy method, a cluster-ion beam method, an ion plating method, a plasma polymerization method, an atmospheric pressure plasma polymerization method, a plasma CVD method, a laser CVD method, a heat CVD method and a coating method are applicable, and the atmospheric pressure plasma polymerization method as described in Japanese Patent O.P.I. Publication No. 2004-68143 is particularly preferred.

As the opaque substrate, for example, a plate of metal such as aluminum and stainless steel, a film or plate of opaque resin and a ceramic substrate are cited.

The external light emission efficiency of the organic electroluminescent element of the invention is preferably not less than 1%, and more preferably not less than 5% at room temperature.

Herein, external quantum yield (%) is represented by the following formula:

External quantum yield (%)=(the number of photons emitted to the exterior of the organic electroluminescent element×100)/(the number of electrons supplied to the organic electroluminescent element)

A hue improving filter such as a color filter may be used in combination or a color conversion filter which can convert color of emission light emitted from an organic EL element to multi-color employing a fluorescent compound may be used in combination. In the case where the color conversion filter is used, the λmax of the light emitted from the organic EL element is preferably not more than 480 nm.

### <<Sealing>>

As the sealing means used in the invention, there is a method in which adhesion of a sealing member to an electrode and a substrate is carried out employing an adhesive agent.

The sealing member is formed so as to cover the displaying area of the organic EL element and may have a flat plate shape or a concave plate shape, and the transparency and the electric insulation property thereof are not specifically limited.

Typical examples of the sealing member include a glass plate, a polymer plate, a polymer film, a metal plate and a metal film. As the glass plate, a plate of soda-lime glass, barium strontium-containing glass, lead glass, aluminosilicate glass, boron silicate glass, barium boron silicate glass or quartz is usable. As the polymer plate, a plate of polycarbonate, acryl resin, polyethylene terephthalate, polyether sulfide or polysulfone is usable. As the metal plate, a plate composed of one or more kinds of metals selected from stainless steel, iron, copper, aluminum, magnesium, nickel, zinc, chromium, titanium, molybdenum, silicon, germanium, tantalum and their alloy is cited.

In the invention, the polymer film and the metal film are preferably used since the element can be made thinner.

The polymer film is one having an oxygen permeability of not more than 1×10⁻³ ml/m²/24 h, measured by a method stipulated in JIS K 7126-1987, and a vapor permeability (at 25±0.5° C. and at (90±2) % RH) of not more than 1×10⁻³ g/(m²/24 h), measured by a method stipulated in JIS K 7129-1992.

For making the sealing material into the concave shape, a sandblast treatment and a chemical etching treatment are used.

As the adhesive agent, there are mentioned a photo-curable or thereto-curable adhesive agent containing a reactive vinyl group such as an acryl type oligomer or a methacryl type oligomer, and a moisture curable adhesive agent such as 2-cyanoacrylate. Examples of the adhesive agent include an epoxy type thermally and chemically (two liquid type) curable adhesive agents, a hot-melt type polyamide, polyester or polyolefin adhesive agents and a cationic curable type UV curable epoxy adhesive agent.

The organic EL element is degraded by heat treatment in some cases, and therefore, an adhesive agent capable of being cured within the temperature range of from room temperature to 80° C. is preferred. A drying agent may be dispersed in the adhesive agent. Coating of the adhesive agent onto the adhering portion may be performed by a dispenser available on the market or by printing such as screen printing.

It is preferred that a layer comprising an inorganic or organic material is formed as a sealing layer on an electrode placed on the side facing a substrate an organic layer provided between the substrate and the electrode, so as to cover the electrode and the organic layer and contact with the substrate. In such a case, a material for forming the sealing layer may be a material having a function to inhibit permeation of a substance such as water and oxygen causing degradation of the element, and for example, silicon oxide, silicon dioxide and silicon nitride are usable. The sealing layer preferably has a multi-laminated layer structure composed of a layer of the inorganic material and a layer of an organic material for improving fragility of the layer.

The method for forming the layer is not specifically limited and, for example, a vacuum deposition method, a spattering method, a reaction spattering method, a molecule beam epitaxy method, a cluster-ion beam method, an ion plating method, a plasma polymerization method, an atmospheric pressure plasma polymerization method, a plasma CVD method, a laser CVD method, a heat CVD method and a coating method are applicable.

In the space between the sealing layer and the displaying portion of the organic EL element, an inactive gas such as nitrogen or argon or an inactive liquid such as fluorinated hydrocarbon or silicone oil is preferably injected in the form of gas or liquid phase. The space can be made vacuum. A hygroscopic compound can be enclosed inside.

Examples of the hygroscopic compound include a metal oxide such as sodium oxide, potassium oxide, calcium oxide, barium oxide, magnesium oxide or aluminum oxide; a sulfate such as sodium sulfate, calcium sulfate, magnesium sulfate or cobalt sulfate; a metal halide such as calcium chloride, magnesium chloride, cesium fluoride, tantalum fluoride, cerium bromide, magnesium bromide, barium iodide or magnesium iodide; and a perchlorate such as barium perchlorate or magnesium perchlorate. An anhydride of the sulfate, halide and perchlorate is suitably applicable.

### <<Protection Layer, Protection Plate>>

A protection layer or a protection plate may be provided on the sealing layer formed on the side facing the substrate through the organic layer or outside the sealing layer in order to raise the mechanical strength of the element. Particularly when sealing is carded out by the sealing layer as described above, such a protection layer or plate is preferably provided, since strength of the element is not so high. As materials for the protection layer or plate, the same glass plate, polymer plate, polymer film, metal plate and metal film as those described above to be used for sealing are usable. The polymer film is preferably used from the viewpoint of light weight and thin layer formation property.

### <<Light Extraction>>

It is generally said that, in the organic EL element, light is emitted in a layer whose refractive index (the refractive index is about 1.7 to 2.1) is higher than that of air, and only 15 to 20% of the light emitted in the light emission layer can be extracted. This is because light which enters a boundary (a boundary between a transparent substrate and the atmosphere) at an angle θ larger than a critical angle is totally reflected and cannot be extracted from the element, or because light is totally reflected at a boundary between the transparent substrate and the transparent electrode or between the transparent substrate and the light emission layer, so that the light exits from the side of the element through the transparent electrode or the light emission layer.

As methods to improve the light extraction efficiency, there are a method to form concavity and convexity on the surface of the transparent substrate to prevent total internal reflection at a boundary between the transparent substrate and atmospheric air (see U.S. Pat. No. 4,774,435); a method to provide light focusing properties to the substrate to improve the efficiency (see Japanese Patent O.P.I. Publication No. 63-314795); a method to form a reflection surface on the side of the element (see Japanese Patent O.P.I. Publication No. 1-220394); a method to form a flat layer having an intermediate refractive index between the substrate and the light emission layer to form an anti-reflection layer (see Japanese Patent O.P.I. Publication No. 62-172691); a method to form a flat layer having a low refractive index between the substrate and the light emission layer (see Japanese Patent O.P.I. Publication No. 2001-202827); and a method to form a diffraction lattice at a boundary between any two of the substrate, the transparent electrode and the light emission layer (including a boundary between the substrate and atmospheric air) (see Japanese Patent O.P.I. Publication No. 11-283751).

In the present invention, these methods can be used in combination with the organic electroluminescent element of the present invention. Also, a method of forming a flat layer having a lower refractive index than that of the substrate between the substrate and the light emission layer, or a method of forming a diffraction lattice at a boundary between any of the substrate, transparent electrode and light emission layer (including a boundary between the substrate and the atmosphere) can be preferably used.

In the present invention, an element exhibiting further higher luminance and durability can be obtained by combining these methods.

When a low refractive index medium with a thickness greater than light wavelength is formed between a transparent electrode and a transparent substrate, the extraction efficiency of light, which comes out of the transparent electrode, increases, as the refractive index of the medium decreases.

As a low refractive index layer, aerogel, porous silica, magnesium fluoride and fluorine-containing polymer are cited, for example. Since refractive index of the transparent substrate is generally 1.5 to 1.7, the refractive index of the low refractive index layer is preferably 1.5 or less and more preferably 1.35 or less.

The thickness of a low refractive index medium is preferably twice or more of the wavelength of the light in the medium, because when the thickness of the low refractive index medium is such that the electromagnetic wave exuding as an evanescent wave enters the transparent substrate, the effect of the low refractive index layer is reduced.

A method to provide a diffraction lattice at a boundary where the total internal reflection occurs or in some of the media has feature that the effect of enhancing the light extraction efficiency increases.

The intension of this method is to provide a diffraction lattice at a boundary between any of the layers or in any of the mediums (in the transparent substrate or in the transparent electrode) and extract light which cannot exit due to total reflection occurring at a boundary between the layers among lights emitted in the light emission layer, which uses the property of the diffraction lattice that can change the direction of light to a specific direction different from the direction of reflection due to so-called Bragg diffraction such as primary diffraction or secondary diffraction.

It is preferred that the diffraction lattice to be provided has a two-dimensional periodic refractive index. This is because, since light generated in the light emission layer is emitted randomly in all the directions, only the light proceeding in a specific direction can be diffracted when a general one-dimensional diffraction lattice having a periodic refractive index distribution only in a specific direction is used, which does not greatly increase the light extraction efficiency.

However, by using a diffraction lattice having a two-dimensional refractive index distribution, the light proceeding in all the directions can be diffracted, whereby the light extraction efficiency is increased.

The diffraction lattice may be provided at a boundary between any of the layers on in any of the mediums (in the transparent substrate or in the transparent electrode), but it is preferably provided in the vicinity of the organic light emission layer where the light is emitted.

The period of the diffraction lattice is preferably about ½ to 3 times the wavelength of light in the medium.

The array of the diffraction lattice is preferably two-dimensionally repeated as in the shape of a square lattice, a triangular lattice, or a honeycomb lattice.

### <<Light Focusing Sheet>>

In the organic EL element of the invention, luminance in a specified direction can be increased, for example, by providing a structure in the form of a micro-lens array on the light extraction side surface of the substrate or in combination with a so-called light focusing sheet, whereby light is focused in a specific direction, for example, in the front direction to the light emitting plane of the element.

As an example of a micro-lens array, there is one in which quadrangular pyramids having a side of 30 μm and having a vertex angle of 90° are two-dimensionally arranged on the light extraction side surface of the substrate. The side of the quadrangular pyramids is preferably from 10 μm to 100 μm.

When the length of the side is shorter than the above range, the light is colored due to the effect of diffraction, while when it is longer than the above range, it becomes unfavorably thick.

As the light focusing sheet, one practically applied for an LED backlight of a liquid crystal display is applicable. Examples of such a sheet include a brightness enhancing film (BEF) produced by SUMITOMO 3M Inc.

As the shape of a prism sheet, there may be included one in which a triangle-shaped strip having a vertex angle of 90° and a pitch of 50 μm provided on a substrate, one having round apexes, one having a randomly changed pitch or other ones.

In order to control an emission angle of light emitted from the light emitting element, a light diffusion plate or film may be used in combination with the light focusing sheet. For example, a diffusion film (Light-Up), produced by KIIMOTO Co., Ltd., can be used.

### <<Use>>

The organic EL element of the invention can be used as a display device, a display, or various light emission sources. Examples of the light emission sources include an illuminating device (a home lamp or a room lamp in a car), a backlight for a watch or a liquid crystal, a light source for boarding advertisement, a signal device, a light source for a photo memory medium, a light source for an electrophotographic copier, a light source for an optical communication instrument, and a light source for an optical sensor, but are not limited thereto. Particularly, it can be effectively used as a backlight for a liquid crystal or a light source for illumination.

In the organic EL element of the invention, patterning may be carried out through a metal mask or according to an ink-jet printing method. The patterning may be carried out only in electrodes, in both electrodes and light emission layer, or in all the layers of the element. Further, the element can be also prepared according to a conventional method.

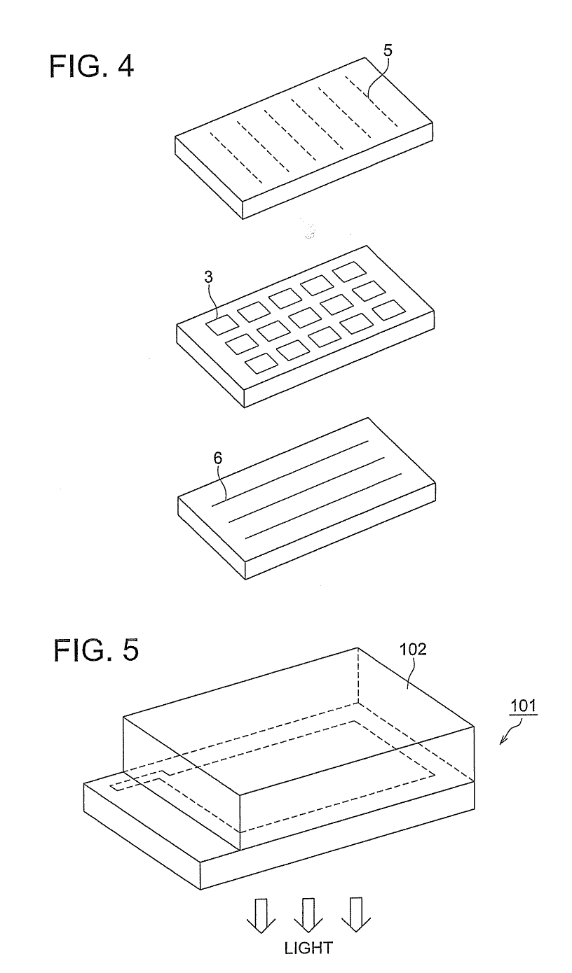

Color of light emitted from the organic EL element of the invention or from the compounds in the invention is specified with color obtained when measurements determined by a spectral radiance luminance meter CS-1000 (produced by Konica Minolta Sensing Co., Ltd.) are applied to the CIE chromaticity coordinates in FIG. 4.16 on page 108 of “Shinpen Shikisai Kagaku Handbook (edited by The Color Science Association of Japan, University of Tokyo Press, 1985).

In the white light emission organic EL element of the invention, “white” means that when front luminance of a 2° viewing angle is determined via the above method, color temperature at 1,000 Cd/m² is in the range of from 7000K to 2500K (deviation Δuv from the black body locus falling within the range of =±0.02).

### <<Display>>

Next, the display of the invention will be explained. The display of the invention comprises the organic EL element as described above.

The constitution of the organic EL element of the invention constituting the display is optionally selected among the constitution examples of the organic EL element as described above.

The manufacturing method of the organic EL element is as described above in one embodiment of the manufacturing method of the organic EL element of the invention.

When a direct current voltage, a voltage of 2V to 40V is applied to the thus manufactured display, setting the anode as a +polarity and the cathode as a −polarity, light emission occurs. When voltage is applied with the reverse polarity, no current flows, and light is not emitted at all. When an alternating voltage is applied, light emission occurs only at the time when the polarity of the anode is “+” and that of the cathode is “−”. The wave shape of the alternating current may be any one.

The display can be used as a display device, a display, or various light emission sources.

Examples of the display device or the display include a television, a personal computer, a mobile device or an AV device, a display for text broadcasting, and an information display used in a car. The display may be used as particularly a display for reproducing a still image or a moving image. When the display is used as a display for reproducing a moving image, the driving method may be either a simple matrix (passive matrix) method or an active matrix method.

Examples of the light emission sources include a home lamp, a room lamp in a car, a backlight for a watch or a liquid crystal, a light source for boarding advertisement, a signal device, a light source for a photo memory medium, a light source for an electrophotographic copier, a light source for an optical communication instrument, and a light source for an optical sensor, but the invention is not limited thereto.

One example of the display comprising the organic EL element of the invention will be explained below employing Figures.

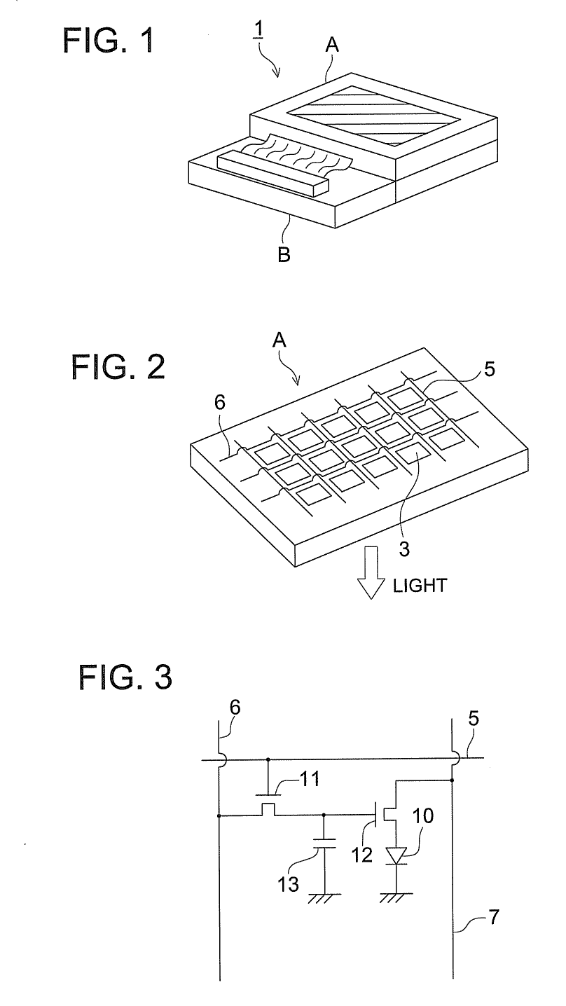

FIG. 1 is a schematic drawing of one example of a display comprising an organic EL element. FIG. 1 is a display such as that of a cellular phone, displaying image information due to light emission from the organic EL element.

A display 1 comprises a display section A having plural pixels and a control section B carrying out image scanning based on image information to display an image in the display section A.

The control section B is electrically connected to the display section A, transmits a scanning signal and an image data signal to each of the plural pixels based on image information from the exterior, and conducts image scanning which emits light from each pixel due to the scanning signal according to the image data signal, whereby an image is displayed on the display section A.

FIG. 2 is a schematic drawing of a display section A.

The display section A comprises a glass substrate, plural pixels 3, and a wiring section comprising plural scanning lines 5 and plural data lines 6. The main members of the display section A will be explained below.

In FIG. 2, light from pixels 3 is emitted in the direction of an arrow.

The plural scanning lines 5 and plural data lines 6 of the wiring section each are composed of an electroconductive material, the lines 5 and the lines 6 being crossed with each other at a right angle, and connected with the pixels 3 at the crossed points (not illustrated).

The plural pixels 3, when the scanning signal is applied from the scanning lines 5, receive the data signal from the data lines 6, and emit light corresponding to the image data received.

Provision of red light emission pixels, green light emission pixels, and blue light emission pixels side by side on the same substrate can display a full color image.

Next, an emission process of pixels will be explained.

FIG. 3 is a schematic drawing of a pixel.

The pixel comprises an organic EL element 10, a switching transistor 11, a driving transistor 12, and a capacitor 13. When a pixel with a red light emission organic EL element, a pixel with a green light emission organic EL element, and a pixel with a blue light emission organic EL element are provided side by side on the same substrate, a full color image can be displayed.

In FIG. 3, an image data signal is applied through the data lines 6 from the control section B to a drain of the switching transistor 11, and when a scanning signal is applied to a gate of the switching transistor 11 through the scanning lines 5 from the control section B, the switching transistor 11 is switched on, and the image signal data applied to the drain is transmitted to the capacitor 13 and the gate of the driving transistor 12.

The capacitor 13 is charged according to the electric potential of the image data signal transmitted, and the driving transistor 12 is switched on. In the driving transistor 12, the drain is connected to an electric source line 7, and the source to an organic EL element 10. Current is supplied from the electric source line 7 to the organic EL element 10 according to the electric potential of the image data signal applied to the gate.

The scanning signal is transmitted to the next scanning line 5 according to the successive scanning of the control section B, the switching transistor 11 is switched off. Even if the switching transistor 11 is switched off, the driving transistor 12 is turned on since the capacitor 13 maintains a charged potential of image data signal, and light emission from the organic EL element 10 continues until the next scanning signal is applied. When the next scanning signal is applied according the successive scanning, the driving transistor 12 works according to an electric potential of the next image data signal synchronized with the scanning signal, and light is emitted from the organic EL element 10.

That is, light is emitted from the organic EL element 10 in each of the plural pixels 3 due to the switching transistor 11 as an active device and the driving transistor 12 each being provided in the organic EL element 10 of each of the plural pixels 3. This emission process is called an active matrix process.

Herein, light emission from the organic EL element 10 may be emission with plural gradations according to image signal data of multiple value having plural gradation potentials, and emission due to on-off according to a binary value of the image data signals. The electric potential of the capacitor 13 may maintain till the next application of the scanning signal, or may be discharged immediately before the next scanning signal is applied.

In the invention, light emission may be carried out employing a passive matrix method as well as the active matrix method as described above. The passive matrix method is one in which light is emitted from the organic EL element according to the data signal only when the scanning signals are scanned.

FIG. 4 is a schematic drawing of a display employing a passive matrix method. In FIG. 4, pixels 3 are provided between the scanning lines 5 and the data lines 6 crossing with each other.

When scanning signal is applied to scanning line 5 according to successive scanning, pixel 3 connecting the scanning line 5 emits according to the image data signal.

The passive matrix method has no active device in the pixel 3, which reduces manufacturing cost of a display.

### <<Illuminating Device>>

Next, the illuminating device of the invention will be explained. The illuminating device of the invention comprises the organic EL element as described above.

The organic EL element of the invention may be an organic EL element having a resonator structure. The organic EL element having a resonator structure is applied to a light source for a photo-memory medium, a light source for an electrophotographic copier, a light source for an optical communication instrument or a light source for a photo-sensor, but its application is not limited thereto. In the above application, a laser oscillation may be carried out.

The organic EL element of the invention can be used as a lamp such as an illuminating lamp or a light source for exposure, as a projection device for projecting an image, or as a display for directly viewing a still image or a moving image.

When the element is used in a display for reproducing a moving image, the driving method may be either a simple matrix (passive matrix) method or an active matrix method. A full color display can be manufactured, employing two or more kinds of organic EL elements each emitting light with a different color.

The organic EL materials in the invention are applied to an organic EL element emitting a substantially white light as an illuminating device. Plural color lights emit from plural light emission materials and are mixed to obtain a white light. As such an admixture of the plural color lights, there is an admixture of the emission maximum wavelength of each of three primary colors blue, green and red or an admixture of the emission maximum wavelength of each of complementary colors such as blue and yellow or blue-green and orange.

As a combination of light emission materials to obtain plural emission colors, there is a combination of plural light emission materials (emitting dopants) emitting plural phosphorescence or fluorescence or a combination of materials emitting phosphorescence or fluorescence and dyes, which are excited by light from the light emission materials to emit light. In the white light emission organic EL element regarding the invention, a combination of plural emitting dopants is preferred.

In the illuminating device, only when the light emission layer, hole transporting layer or electron transporting layer only is formed, a shadow mask is used, whereby a simple coating is carried out through the mask, and other layers, which are common, can be formed employing a vacuum method, a casting method, a spin coat method or a printing method which does not require patterning employing the mask, increasing productivity.

According to the process described above, the element itself emits white light, which is different from a white light emission organic EL device in which plural light emission elements are arranged in parallel in an array form.

The light emission materials used in the light emission layer are not specifically limited. For example, in a back light of a liquid crystal display, platinum complex in the invention or known light emission materials are appropriately selected to suit the wavelength range corresponding to the CF (color filter) and mixed to obtain a white light

### <<One Embodiment of Illuminating Device of the Invention>>

One embodiment of the illuminating device of the invention comprising the organic EL element in the invention

Will be explained.

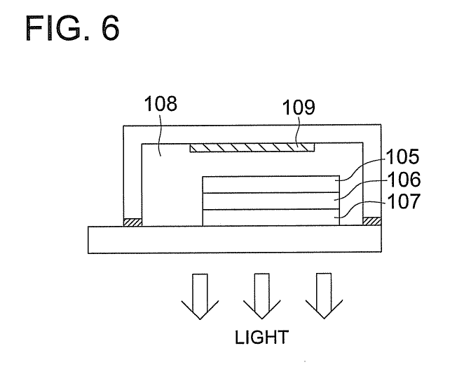

The non-light-emitting face of the organic EL element of the invention is covered with a glass case, and a sealing glass plate having a thickness of 300 μm is piled as a sealing substrate on the cathode so as to be contacted with the transparent substrate, an epoxy type photocurable adhesive, Laxtruck LC0629B (manufactured by Toa Gousei Co., Ltd.) being applied as a sealing material onto the periphery of the glass plate, and then the adhesive is cured by UV ray irradiation from the glass plate to seal. Thus, an illuminating device as shown in FIG. 5 or 6 is prepared.

FIG. 5 shows a schematic drawing of an illuminating device. The organic EL element 101 of the invention is covered with a glass cover 102. (The sealing of the glass cover is carried out in a globe box filled with nitrogen gas (highly purified nitrogen gas having a purity of 99.999% or more) so that the organic EL element 101 did not contact atmospheric air.)

FIG. 6 is a sectional view of an illuminating device. In FIG. 6, numerical No. 105 is a cathode, numerical No. 106 is an organic EL layer, and numerical No. 107 is a glass substrate with a transparent electrode. In the inside of the glass cover 102, nitrogen gas 108 is introduced and a water-trapping agent 109 is placed.

### EXAMPLES

The present invention will be explained in the following examples, but is not limited thereto. The chemical structures of compounds used in the examples will be shown below.

In the examples, “parts” and “%” show “parts by mass” and “% by mass”, unless otherwise specified.

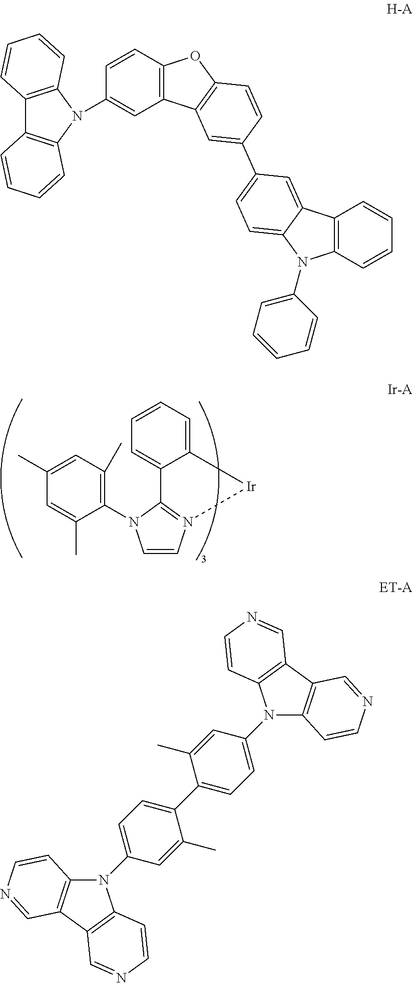

### Example 1

### Preparation of Organic EL Element Sample 1

A substrate, which is composed of a glass plate (100 mm×100 mm×1.1 mm) and a 100 nm ITO (indium tin oxide) layer as an anode, was subjected to patterning treatment. Then the resulting transparent substrate having the ITO transparent electrode was subjected to ultrasonic washing in isopropyl alcohol, dried by a dry nitrogen gas and subjected to UV-ozone cleaning for 5 minutes.

A solution, in which poly(3,4-ethylenedioxythiophene)-polystyrene sulfonate (PEDOT/PSS, Baytron P AI 4083, produced by Bayer Co., Ltd.) was diluted by pure water to 70%, was coated on the transparent substrate at 3000 rpm for 5 minute through a spin coating method, and dried at 180° C. for 30 minutes to form a hole injecting layer with a thickness of 30 nm.

Subsequently, a solution in which 20 mg of Compound 4-16 was dissolved in 4 ml of toluene was coated on the substrate under nitrogen atmosphere at 1500 rpm for 30 seconds through a spin coating method, dried at 80° C. for 30 minutes and subjected to UV irradiation for 30 seconds employing a UV lamp with an output power of 35 mW/cm thereby causing polymerization and crosslinking, whereby a hole transporting layer with a thickness of 20 nm was formed.

The light emission layer composition having the following composition was coated on the substrate obtained above at 1500 rpm for 30 seconds through a spin coating method, and dried at 80° C. for 30 minutes to form a light emission layer with a thickness of 50 nm.

(LIGHT EMISSION LAYER COMPOSITION)

| | | |
|---|---|---|
| H-A | 22.4 | parts by mass |
| Ir-A | 2.5 | parts by mass |
| Ir-1 | 0.05 | parts by mass |
| Ir-14 | 0.05 | parts by mass |
| Toluene | 2000 | parts by mass |

The thus obtained material was put in a vacuum deposition apparatus without being exposed to atmospheric air. Further, a first resistive heating molybdenum boat charged with ET-A and a second resistive heating molybdenum boat charged with CsF were put in the vacuum deposition apparatus. Subsequently, pressure in the vacuum tank was reduced to 4×10⁻⁴ Pa, and the boats being supplied with an electric current and heated, ET-A at a rate of 0.2 nm/second and CsF at a rate of 0.2 nm/second were co-deposited on the light emission layer to form an electron transporting layer with a thickness of 20 nm. Successively, a 110 nm thick aluminum was deposited on the electron transporting layer to form a cathode. Thus, Organic EL Element Sample 1 was prepared.

Thereafter, Organic EL Element Sample 1-1 was placed in a globe box filled with nitrogen gas (highly purified nitrogen gas having a purity of 99.999% or more), without being exposed to atmospheric air, and the non-light-emitting face thereof was covered with a glass cover 102. Thus, Organic EL Element Sample 1 was prepared. In the inside of the glass cover 102, nitrogen gas 108 is introduced and a water-trapping agent 109 is provided.

### <<Preparation of Organic EL Element Samples 2 Through 8>>

Organic EL Element Samples 2 through 8 were prepared in the same manner as in Organic EL Element Sample 1, except that the light emission layer composition was varied as shown in Table 1.

The light emission dopants, the addition amount (parts by mass) of the dopants, and amount used (parts by mass) of toluene employed for preparation of Organic EL Element Samples 1 through 8 are collectively shown in Table 1.

TABLE 1

| | | Light Emission | Light Emission | Light Emission | Light Emission | | |
|---|---|---|---|---|---|---|---|
| Sample | Host | Material-1 | Material-2 | Material-3 | Material-4 | Solvent | |
| No. | (parts by mass) | (parts by mass) | (parts by mass) | (parts by mass) | (parts by mass) | (parts by mass) | Remarks |
| 1 | H-A (22.4) | Ir-A (2.5) | Ir-1 (0.05) | Ir-14 (0.05) | — (—) | Toluene (2000) | Inv. |
| 2 | H-A (20.9) | Ir-A (4) | Ir-1 (0.05) | Ir-14 (0.05) | — (—) | Toluene (2000) | Inv. |
| 3 | H-A (22.4) | Ir-A (2.5) | Ir-14 (0.1) | — (—) | — (—) | Toluene (2000) | Inv. |
| 4 | H-A (22.15) | Ir-A (2.5) | Ir-1 (0.05) | Ir-14 (0.3) | — (—) | Toluene (2000) | Inv. |
| 5 | H-A (19.85) | Ir-A (5) | Ir-1 (0.05) | Ir-14 (0.05) | Ir-15 (0.05) | Toluene (2000) | Inv. |
| 6 | H-A (19.875) | Ir-A (5) | Ir-1 (0.05) | Ir-14 (0.05) | Ir-15 (0.025) | Toluene (2000) | Inv. |
| 7 | H-A (19.9) | Ir-A (5) | Ir-1 (0.05) | Ir-14 (0.025) | Ir-15 (0.025) | Toluene (2000) | Inv. |
| 8 | H-A (22.4) | Ir-16 (2.5) | Ir-1 (0.05) | Ir-14 (0.05) | — (—) | Toluene (2000) | Comp. |

Inv.: Inventive;
Comp.: Comparative

### <<Evaluation of Organic EL Elements>>

With respect to Organic EL Element Samples 1 through 8, the emission spectra were measured at a front luminescence of 1,000 cd/m², employing a spectral radiance luminance meter CS-1000 (produced by Konica Minolta Sensing, Inc.).

Employing the measurements obtained above, emission minimum wavelengths in a wavelength region of from 480 nm to 510 nm and emission maximum wavelengths were confirmed, a color temperature (T) and a color difference (Δuv) were determined, and an average color rendering index (Ra) was determined by a method according to JIS Z 8726-1990.

Evaluation was made according to the following criteria and the results are shown in Table 2.

(COLOR TEMPERATURE T)

| | | |
|---|---|---|
| A: | 2500 > T | Light is too reddish to use as an illuminating |
| | | device |
| B: | 3200 > T ≧ 2500 K | Warm white |
| C: | 4600 > T ≧ 3200 K | White |
| D: | 5500 > T ≧ 4600 K | Neutral white |
| E: | 7000 > T ≧ 5500 K | Daylight color |
| F: | T > 7000 K | Light is too bluish to use as an illuminating |
| | | device |

(COLOR DIFFERENCE Δuv)

| | | |
|---|---|---|
| A: | Δuv ≦ ± 0.02 | The color temperature approximates the |
| | | black body locus. |
| C: | Δuv > ± 0.02 | The color temperature is away from the |
| | | black body locus, and the correlated color |
| | | temperature value cannot be given. |

(COLOR RENDERING PROPERTY Ra)

| | | |
|---|---|---|
| AA: | Ra ≧ 80 | Color rendering property is excellent. |
| A: | 80 > Ra ≧ 70 | Color rendering property is sufficient for practical |
| | | use. |
| B: | 70 > Ra ≧ 60 | Color rendering property is a little poor. |
| C: | 60 > Ra | Color rendering property is poor and cannot be |
| | | applied practical use. |

### (Evaluation of Chromaticity Stability to Driving Current Variation)

The chromaticity x1 and y1 of each EL element sample to which a current density of 1 mA/cm² was supplied and the chromaticity x2 and y2 of each EL element sample to which a current density of 5 mA/cm² was supplied were determined employing a spectral radiance luminance meter CS-1000 (produced by Konica Minolta Sensing, Inc.). Then, the chromaticity difference ΔE1 was calculated using the following formula 1.

In formula 1 below, x1 and y1, and x2 and y2 represent chromaticity values x and y in CIE 1931 color space.

ΔE1=[(x1−x2)²+(y1−x2)²]^{0.5} (Formula 1)

The results are evaluated according to the following criteria and shown in Table 2.

| | | |
|---|---|---|
| A: | 0.01 ≧ ΔE1 | Chromaticity variation is extremely small and |
| | | especially preferred. |
| B: | 0.03 ≧ ΔE1 > 0.01 | Chromaticity variation is small and preferred. |
| C | ΔE1 > 0.03 | Chromaticity varies. |

### (Evaluation of Chromaticity Stability During Driving)

A front luminance of 1,000 cd/m² was set as an initial luminance and luminance variation after continuous driving was determined. Chromaticity at t=0, x3 and y3, and chromaticity after the luminance decreased to the half, x4 and y4 were determined employing a spectral radiance luminance meter CS-1000 (produced by Konica Minolta Sensing, Inc.). Then, the chromaticity difference ΔE2 was calculated using the following formula 2. In formula 2 below, x3 and y3, and x4 and y4 represent chromaticity values x and y in CIE 1931 color space.

ΔE2=[(x3−x4)²+(y3−y4)²]^{0.5} (Formula 2)

The results are evaluated according to the following criteria and shown in Table 2.

| | | |
|---|---|---|
| A: | 0.05 ≧ ΔE2 | Chromaticity variation is extremely small and |
| | | especially preferred. |
| B: | 0.10 ≧ ΔE2 > 0.05 | Chromaticity variation is small and preferred.) |
| C: | ΔE2 > 0.10 | Chromaticity varies. |

TABLE 2

| | | Emission | | | | | | | | |
|---|---|---|---|---|---|---|---|---|---|---|
| | Emission Maximum | Minimum (nm) In | Light Emission | Light Emission | | | | | | |
| Sample | Wavelength | The Range Of 480 | Material Content | Material Ratio | | | | | | |
| No. | (nm) | To 510 nm | (% by mass) | (β/α) | (a) | (b) | (c) | (d) | (e) | Remarks |
| 1 | 473/505/515/622 | Present | 10.4 | 0.02 | B | A | A | A | A | Inv. |
| 2 | 473/505/515/622 | Present | 16.4 | 0.0125 | D | A | A | A | A | Inv. |
| 3 | 473/505/622 | Present | 10.4 | 0.04 | E | B | B | A | A | Inv. |
| 4 | 473/505/622 | Present | 11.4 | 0.12 | A | B | B | A | A | Inv. |
| 5 | 473/505/515/585/622 | Present | 20.6 | 0.02 | B | A | AA | A | A | Inv. |
| 6 | 473/505/515/585/622 | Present | 20.5 | 0.015 | C | A | AA | A | A | Inv. |
| 7 | 473/505/515/585/622 | Present | 20.4 | 0.01 | D | A | AA | A | A | Inv. |
| 8 | 458/505/515/622 | Absent | 10.4 | 0.02 | D | A | C | C | B | Comp. |

Inv.: Inventive;
Comp.: Comparative
(a): Color Temperature T (K)
(b): Color Difference Δuv
(c): Color Rendering Property Ra
(d): Chromaticity Stability Due To Driving Current Variation
(e): Chromaticity Stability After Continuous Driving

As is apparent from Table 2, the inventive organic EL element samples 1 through 7, which have three or more emission maximums in a wavelength region of from 420 nm to 650 nm and an emission minimum in a wavelength region of from 480 nm to 510 nm, provide excellent color tone or color rendering property, excellent chromaticity stability to driving current variation and excellent chromaticity stability during continuous driving, as a white light emission organic EL element, and can be preferably employed as an illuminating device.

On the other hand, the comparative organic EL element sample 8, which does not have an emission minimum in a wavelength region of from 480 nm to 510 nm, is insufficient in color rendering property, chromaticity stability to driving current variation and chromaticity stability during continuous driving.

It has proved that the inventive organic EL element samples 5 through 7, whose emission spectra have four or more emission maximums and a wavelength difference between two adjacent emission maximum wavelengths of from 30 nm to 70 nm, have more useful performances as an illuminating device with excellent color rendering property.

It has proved that the organic EL element samples 1, 2, 5, 6 and 7, in which in the emission spectrum of two light emission materials having an emission maximum adjacent to each other among the plurality of light emission materials, the emission intensity is 30 or more at the wavelength where the emission spectrum of each of the two light emission materials overlaps, when the intensity of each emission maximum is set at 100, excel in color difference and in color rendering property, as compared with the organic EL element samples 3 and 4 in which the emission intensity is outside that range.

It is apparent that the organic EL element samples 5 through 7, satisfying the following formula, are white light emission organic EL elements having further superior color rendering property, as compared to organic EL element samples, which do not satisfy the formula,

λmax(½)−λmax≧40 nm

wherein λmax represents the longest emission maximum wavelength in the emission maximums, and λmax (½) represents a wavelength which is on the wavelength side longer than the longest emission maximum wavelength and which exhibits ½ of the intensity of the emission maximum at the longest emission maximum wavelength.

### EXPLANATION OF SYMBOLS

1. Display
3. Pixel
5. Scanning line
6. Data line
7. Electric source line 7
10. Organic EL element
11. Switching transistor
12. Driving transistor
13. Capacitor
A. Display section
B. Control section
101. Organic EL element
102. Glass cover
105. Cathode
106. Organic EL layer
107. Glass substrate with transparent electrode
108. Nitrogen gas
109. Water trapping agent

1. A white light emission organic electroluminescent element comprising an anode side electrode, a cathode side electrode and at least one constituent layer provided between the anode side electrode and the cathode side electrode, the constituent layer comprising one or more light emission layers, in which at least one of the light emission layers contains a plurality of light emission materials having a different emission color, wherein the emission spectrum of the element has at least three emission maximums in a wavelength region of from 420 nm to 650 nm and an emission minimum in a wavelength region of from 480 nm to 510 nm, and has two adjacent emission maximum wavelengths, a wavelength difference between the two adjacent emission maximum wavelengths being from 30 nm to 70 nm.

2. The white light emission organic electroluminescent element of claim 1, wherein the emission spectrum has the emission maximum at least in each of a wavelength region of from 420 nm to 480 nm, a wavelength region of from 510 nm to 610 nm and a wavelength region of from 555 nm to 650 nm.

3. The white light emission organic electroluminescent element of claim 1, wherein the emission spectrum has four emission maximums in a wavelength region of from 420 nm to 650 nm.

4. The white light emission organic electroluminescent element of claim 1, wherein in the emission spectrum of two light emission materials having an emission maximum adjacent to each other among the plurality of light emission materials, the emission intensity is 30 or more at the wavelength where the emission spectrum of each of the two light emission materials overlaps, when the intensity of each emission maximum is set at 100.

5. The white light emission organic electroluminescent element of claim 1, wherein light emitted from the element has a color temperature of from 2500K to 7000K and a color difference Δuv falling within the range of ±0.02.

6. The white light emission organic electroluminescent element of claim 1, wherein the emission spectrum of at least one of the plurality of light emission materials has an emission maximum in a wavelength region of from 420 nm to 480 nm, and has two emission maximums which are double peaks.

7. The white light emission organic electroluminescent element of claim 1, wherein all of the plurality of light emission materials are phosphorescence emission materials.

8. The white light emission organic electroluminescent element of claim 1, wherein the light emission materials include a compound having at least one of partial structures represented by the following formulae (A) to (C): 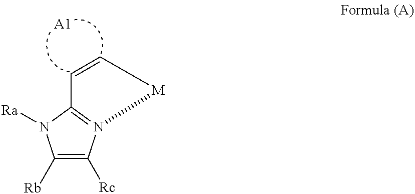
wherein Ra represents a hydrogen atom, an aliphatic group, an aromatic hydrocarbon group or an aromatic heterocyclic group; Rb and Rc independently represent a hydrogen atom or a substituent; A1 represents an atomic group necessary to form an aromatic hydrocarbon ring or an aromatic heterocyclic ring; and M represents Ir or Pt; 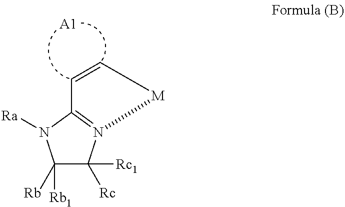
wherein Ra represents a hydrogen atom, an aliphatic group, an aromatic hydrocarbon group or an aromatic heterocyclic group; Rb, Rc, Rb₁, and Rc₁ independently represent a hydrogen atom or a substituent; A1 represents an atomic group necessary to form an aromatic hydrocarbon ring or an aromatic heterocyclic ring; and M represents Ir or Pt; 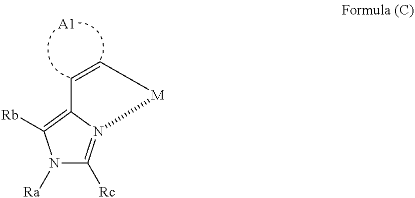
wherein Ra represents a hydrogen atom, an aliphatic group, an aromatic hydrocarbon group or an aromatic heterocyclic group; Rb and Rc independently represent a hydrogen atom or a substituent; A1 represents an atomic group necessary to form an aromatic hydrocarbon ring or an aromatic heterocyclic ring; and M represents Ir or Pt.

9. The white light emission organic electroluminescent element of claim 1, wherein the plurality of light emission materials comprise two or more kinds of light emission materials having an emission maximum in a wavelength region of from 555 nm to 650 nm.

10. The white light emission organic electroluminescent element of claim 1, wherein the emission spectrum satisfies the following formula:
λmax(½)−λmax≧40 nm
wherein λmax represents the longest emission maximum wavelength in the emission maximums spectrum; and λmax (½) represents a wavelength which is on the wavelength side longer than the longest emission maximum wavelength and which exhibits ½ of the intensity of the emission maximum at the longest emission maximum wavelength.

11. The white light emission organic electroluminescent element of claim 1, wherein the total content of the light emission materials in the light emission layer is from 5 to 30% by mass.

12. The white light emission organic electroluminescent element of claim 1, the plurality of light emission materials comprising a first light emission material having an emission maximum in a wavelength region of from 420 nm to 480 nm and a second light emission material having an emission maximum in a wavelength region of from 555 nm to 650 nm, wherein when the content by mass of the first light emission material in the light emission layer is represented by α and the content by mass of the second light emission material in the light emission layer is represented by β, a ratio by mass β/α satisfies the following inequality:
β/α<0.1

13. The white light emission organic electroluminescent element of claim 12, the plurality of light emission materials comprising a first light emission material having an emission maximum in a wavelength region of from 420 nm to 480 nm and a second light emission material having an emission maximum in a wavelength region of from 555 nm to 650 nm, wherein when the content by mass of the first light emission material in the light emission layer is represented by α and the content by mass of the second light emission material in the light emission layer is represented by β, a ratio by mass β/α satisfies the following inequality:
β/α<0.05

14. The white light emission organic electroluminescent element of claim 1, wherein at least one of the light emission layers is formed by a wet process.

15. An illuminating device comprising the white light emission organic electroluminescent element of claim 1.

16. A display comprising the white light emission organic electroluminescent element of claim 1.
